(19) United States
(12) Patent Application Publication
(10) Pub. No.: US 2025/0294596 A1
(43) Pub. Date: Sep. 18, 2025

(54) TECHNIQUES FOR SIDELINK CARRIER AGGREGATION WITH MODE 1 SIDELINK COMMUNICATIONS

(71) Applicant: QUALCOMM Incorporated, San Diego, CA (US)

(72) Inventors: Kazuki TAKEDA, Minato-ku (JP); Sony AKKARAKARAN, Poway, CA (US); Jelena DAMNJANOVIC, Del Mar, CA (US)

(21) Appl. No.: 18/607,177

(22) Filed: Mar. 15, 2024

(51) Int. Cl. H04W 72/40; H04L 5/00; H04W 72/23

(52) U.S. Cl. CPC H04W 72/40; H04L 5/0053; H04L 5/0094; H04W 72/23

(57) ABSTRACT

Methods, systems, and devices for wireless communications are described. In some cases, a first user equipment (UE) may receive, from a network entity via an access link, a first control message enabling sidelink carrier aggregation between a first UE and a second UE, the sidelink carrier aggregation associated with at least multiple sidelink carriers for sidelink communication between the first UE and the second UE. Additionally, the first UE may receive, from the network entity via one or more downlink carriers of an access link, one or more second control messages scheduling transmission of multiple sidelink messages over the multiple sidelink messages based on the first control message. As such, the first UE may communicate the multiple sidelink messages via the multiple sidelink carriers based on the one or more second control messages.

### FIELD OF TECHNOLOGY

The following relates to wireless communications, including techniques for sidelink carrier aggregation (CA) with Mode 1 sidelink communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for sidelink carrier aggregation (CA) with Mode 1 sidelink communications. Generally, the techniques described herein may enable a first user equipment (UE) to receive, via an access link with a network entity, one or more control messages scheduling transmission of multiple sidelink messages over multiple sidelink carriers. For example, the first UE may receive, from the network entity via the access link, a first control message enabling sidelink CA between the first UE and a second UE. In such cases, the first UE and the second UE may support multiple sidelink carriers for sidelink communications between the first UE and the second UE. Additionally, the UE may receive, from the network entity via the access link one or more second control messages scheduling transmission of multiple sidelink messages over at least a subset of the multiple sidelink carriers based on sidelink CA being enabled. In some cases, the first UE may receive the one or more second control messages via a single downlink carrier of the access link. In some other cases, the first UE may receive the one or more second control messages via multiple downlink carriers of the access link. As such, the first UE may communicate the multiple sidelink messages via the at least subset of the multiple sidelink carriers based on the one or more second control messages.

Further, the first UE may transmit, to the network entity via the access link, feedback for the multiple sidelink messages. In some cases, the first UE may transmit a single uplink feedback message including feedback for the multiple sidelink messages. In such cases, the first UE may transmit the uplink feedback message a threshold duration after receipt of a last sidelink feedback message of multiple sidelink feedback messages indicating the feedback for the multiple sidelink messages. In some other cases, the first UE may transmit a respective uplink feedback message in response to each sidelink feedback message of the multiple sidelink feedback messages.

A method for wireless communications by a UE is described. The method may include receiving, from a network entity via an access link, a first control message enabling sidelink CA between the first UE and a second UE, the sidelink CA associated with a set of multiple sidelink carriers for sidelink communication between the first UE and the second UE, receiving, from the network entity via the access link, one or more second control messages scheduling transmission of a set of multiple sidelink messages over multiple sidelink carriers of the set of multiple sidelink carriers based on the first control message, and communicating the set of multiple sidelink messages via the multiple sidelink carriers associated with the sidelink carrier aggregation based on the one or more second control messages.

A first UE for wireless communications is described. The first UE may include one or more memories storing processor executable code, and one or more processors coupled with the one or more memories. The one or more processors may individually or collectively be operable to execute the code to cause the first UE to receive, from a network entity via an access link, a first control message enabling sidelink CA between the first UE and a second UE, the sidelink CA associated with a set of multiple sidelink carriers for sidelink communication between the first UE and the second UE, receive, from the network entity via the access link, one or more second control messages scheduling transmission of a set of multiple sidelink messages over multiple sidelink carriers of the set of multiple sidelink carriers based on the first control message, and communicate the set of multiple sidelink messages via the multiple sidelink carriers associated with the sidelink carrier aggregation based on the one or more second control messages.

Another first UE for wireless communications is described. The first UE may include means for receiving, from a network entity via an access link, a first control message enabling sidelink CA between the first UE and a second UE, the sidelink CA associated with a set of multiple sidelink carriers for sidelink communication between the first UE and the second UE, means for receiving, from the network entity via the access link, one or more second control messages scheduling transmission of a set of multiple sidelink messages over multiple sidelink carriers of the set of multiple sidelink carriers based on the first control message, and means for communicating the set of multiple sidelink messages via the multiple sidelink carriers associated with the sidelink carrier aggregation based on the one or more second control messages.

A non-transitory computer-readable medium storing code for wireless communications is described. The code may include instructions executable by one or more processors to receive, from a network entity via an access link, a first control message enabling sidelink CA between the first UE and a second UE, the sidelink CA associated with a set of multiple sidelink carriers for sidelink communication between the first UE and the second UE, receive, from the network entity via the access link, one or more second control messages scheduling transmission of a set of multiple sidelink messages over multiple sidelink carriers of the set of multiple sidelink carriers based on the first control message, and communicate the set of multiple sidelink messages via the multiple sidelink carriers associated with the sidelink carrier aggregation based on the one or more second control messages.

In some examples of the method, UEs, and non-transitory computer-readable medium described herein, receiving the one or more second control messages may include operations, features, means, or instructions for receiving, via one or more downlink carriers of the access link, a set of multiple second control messages, each second control message of the set of multiple second control messages scheduling a respective sidelink message of the set of multiple sidelink messages over a respective sidelink carrier of the multiple sidelink carriers.

Some examples of the method, UEs, and non-transitory computer-readable medium described herein may further include operations, features, means, or instructions for monitoring, for each second control message of the set of multiple second control messages, up to a first quantity of downlink control channel candidates and up to a second quantity of non-overlapping control channel elements for the set of multiple second control messages.

In some examples of the method, UEs, and non-transitory computer-readable medium described herein, the first quantity and the second quantity may be based on a SCS of an active downlink BWP associated with the network entity.

In some examples of the method, UEs, and non-transitory computer-readable medium described herein, the set of multiple second control messages may be received via a single downlink carrier and the method, apparatuses, and non-transitory computer-readable medium may include further operations, features, means, or instructions for monitoring, for each second control message of the set of multiple second control messages, up to a first portion of a first quantity of downlink control channel candidates and up to a second portion of a second quantity of non-overlapping control channel elements.

In some examples of the method, UEs, and non-transitory computer-readable medium described herein, the first quantity and the second quantity may be based on a SCS of an active downlink BWP associated with the network entity.

In some examples of the method, UEs, and non-transitory computer-readable medium described herein, both a quantity of downlink control channel candidates in the first portion and a quantity of non-overlapping control channel elements in the second portion may be the same for each second control message.

In some examples of the method, UEs, and non-transitory computer-readable medium described herein, both a third quantity of downlink control channel candidates in the first portion and a fourth quantity of non-overlapping control channel elements in the second portion may be different for each second control message and the method, apparatuses, and non-transitory computer-readable medium may include further operations, features, means, or instructions for receiving, from the network entity, an indication of respective third quantities and respective second quantities for each second control message of the set of multiple second control messages.

In some examples of the method, UEs, and non-transitory computer-readable medium described herein, receiving the one or more second control messages may include operations, features, means, or instructions for receiving, via a single downlink carrier of the access link, a single second control message, the single second control message scheduling the set of multiple sidelink messages over the multiple sidelink carriers.

In some examples of the method, UEs, and non-transitory computer-readable medium described herein, the single second control message indicates a set of multiple sets of parameters for the set of multiple sidelink messages.

In some examples of the method, UEs, and non-transitory computer-readable medium described herein, a first set of parameters of the set of multiple sets of parameters includes a resource pool index, a time gap, a HARQ process, a new data indicator, a lowest index of sub-channel, a frequency domain resource assignment, a time domain resource assignment, a feedback timing, an uplink control channel resource, a configuration index, a counter sidelink assignment index, or any combination thereof.

In some examples of the method, UEs, and non-transitory computer-readable medium described herein, the first control message indicates the single downlink carrier may be a scheduling downlink carrier.

Some examples of the method, UEs, and non-transitory computer-readable medium described herein may further include operations, features, means, or instructions for transmitting, to the network entity via the access link, feedback for the set of multiple sidelink messages.

In some examples of the method, UEs, and non-transitory computer-readable medium described herein, transmitting the feedback may include operations, features, means, or instructions for transmitting a single feedback message indicating the feedback for the set of multiple sidelink messages.

Some examples of the method, UEs, and non-transitory computer-readable medium described herein may further include operations, features, means, or instructions for receiving, from the second UE via one or more sidelink carriers of the multiple sidelink carriers, a set of multiple sidelink feedback messages indicating the feedback for the set of multiple sidelink messages, where the single feedback message may be transmitted a threshold time duration after receipt of a last sidelink feedback message of the set of multiple sidelink feedback messages.

In some examples of the method, UEs, and non-transitory computer-readable medium described herein, transmitting the feedback may include operations, features, means, or instructions for transmitting a set of multiple feedback messages for the set of multiple sidelink messages, each feedback message of the set of multiple feedback messages indicating feedback for a respective sidelink message of the set of multiple sidelink messages.

Some examples of the method, UEs, and non-transitory computer-readable medium described herein may further include operations, features, means, or instructions for receiving, from the second UE via one or more sidelink carriers of the multiple sidelink carriers, a set of multiple sidelink feedback messages indicating the feedback for the set of multiple sidelink messages, where each feedback message of the set of multiple feedback messages may be transmitted a threshold duration after a respective sidelink feedback message of the set of multiple sidelink feedback messages.

A method for wireless communications by a network entity is described. The method may include outputting, to a first UE via an access link, a first control message enabling sidelink CA between the first UE and a second UE, the sidelink CA associated with a set of multiple sidelink carriers for sidelink communication between the first UE and the second UE, outputting, to the first UE via the access link, one or more second control messages scheduling transmission of a set of multiple sidelink messages over multiple sidelink carriers of the set of multiple sidelink carriers based on the first control message, and obtaining, from the first UE via the access link, feedback for the set of multiple sidelink messages.

A network entity for wireless communications is described. The network entity may include one or more memories storing processor executable code, and one or more processors coupled with the one or more memories. The one or more processors may individually or collectively be operable to execute the code to cause the network entity to output, to a first UE via an access link, a first control message enabling sidelink CA between the first UE and a second UE, the sidelink CA associated with a set of multiple sidelink carriers for sidelink communication between the first UE and the second UE, output, to the first UE via the access link, one or more second control messages scheduling transmission of a set of multiple sidelink messages over multiple sidelink carriers of the set of multiple sidelink carriers based on the first control message, and obtain, from the first UE via the access link, feedback for the set of multiple sidelink messages.

Another network entity for wireless communications is described. The network entity may include means for outputting, to a first UE via an access link, a first control message enabling sidelink CA between the first UE and a second UE, the sidelink CA associated with a set of multiple sidelink carriers for sidelink communication between the first UE and the second UE, means for outputting, to the first UE via the access link, one or more second control messages scheduling transmission of a set of multiple sidelink messages over multiple sidelink carriers of the set of multiple sidelink carriers based on the first control message, and means for obtaining, from the first UE via the access link, feedback for the set of multiple sidelink messages.

A non-transitory computer-readable medium storing code for wireless communications is described. The code may include instructions executable by one or more processors to output, to a first UE via an access link, a first control message enabling sidelink CA between the first UE and a second UE, the sidelink CA associated with a set of multiple sidelink carriers for sidelink communication between the first UE and the second UE, output, to the first UE via the access link, one or more second control messages scheduling transmission of a set of multiple sidelink messages over multiple sidelink carriers of the set of multiple sidelink carriers based on the first control message, and obtain, from the first UE via the access link, feedback for the set of multiple sidelink messages.

In some examples of the method, network entities, and non-transitory computer-readable medium described herein, outputting the one or more second control messages may include operations, features, means, or instructions for outputting, via a single downlink carrier of the access link, a set of multiple second control messages, each second control message of the set of multiple second control messages scheduling a respective sidelink message of the set of multiple sidelink messages over a respective sidelink carrier of the multiple sidelink carriers.

In some examples of the method, network entities, and non-transitory computer-readable medium described herein, outputting the one or more second control messages may include operations, features, means, or instructions for outputting, via a set of multiple downlink carriers of the access link, a set of multiple second control messages, each second control message of the set of multiple second control messages scheduling a respective sidelink message of the set of multiple sidelink messages over a respective sidelink carrier of the multiple sidelink carriers.

Some examples of the method, network entities, and non-transitory computer-readable medium described herein may further include operations, features, means, or instructions for outputting, to the UE, an indication of respective quantities of downlink control channel candidates and respective quantities of non-overlapping control channel elements for the first UE to monitor for each second control message of the one or more second control messages.

In some examples of the method, network entities, and non-transitory computer-readable medium described herein, transmitting the one or more second control messages may include operations, features, means, or instructions for outputting, via a single downlink carrier of the access link, a single second control message, the single second control message scheduling the set of multiple sidelink messages over the multiple sidelink carriers.

In some examples of the method, network entities, and non-transitory computer-readable medium described herein, the single second control message indicates a set of multiple sets of parameters for the set of multiple sidelink messages.

In some examples of the method, network entities, and non-transitory computer-readable medium described herein, a first set of parameters of the set of multiple sets of parameters includes a resource pool index, a time gap, a HARQ process, a new data indicator, a lowest index of sub-channel, a frequency domain resource assignment, a time domain resource assignment, a feedback timing, an uplink control channel resource, a configuration index, a counter sidelink assignment index, or any combination thereof.

In some examples of the method, network entities, and non-transitory computer-readable medium described herein, the first control message indicates the single downlink carrier may be a scheduling downlink carrier.

In some examples of the method, network entities, and non-transitory computer-readable medium described herein, obtaining the feedback may include operations, features, means, or instructions for obtaining, via the access link, a single feedback message indicating the feedback for the set of multiple sidelink messages.

In some examples of the method, network entities, and non-transitory computer-readable medium described herein, obtaining the feedback may include operations, features, means, or instructions for obtaining, via the access link, a set of multiple feedback messages for the set of multiple sidelink messages, each feedback message of the set of multiple feedback messages indicating feedback for a respective sidelink message of the set of multiple sidelink messages.

### BRIEF DESCRIPTION OF THE DRAWINGS

FIG. 1 shows an example of a wireless communications system that supports techniques for sidelink carrier aggregation with Mode 1 sidelink communications in accordance with one or more aspects of the present disclosure.

FIG. 2 shows an example of a wireless communications system that supports techniques for sidelink carrier aggregation with Mode 1 sidelink communications in accordance with one or more aspects of the present disclosure.

FIG. 3 shows an example of scheduling configurations that support techniques for sidelink carrier aggregation with Mode 1 sidelink communications in accordance with one or more aspects of the present disclosure.

FIG. 4 shows an example of a scheduling configuration that supports techniques for sidelink carrier aggregation with Mode 1 sidelink communications in accordance with one or more aspects of the present disclosure.

FIG. 5 shows an example of timing diagrams that support techniques for sidelink carrier aggregation with Mode 1 sidelink communications in accordance with one or more aspects of the present disclosure.

FIG. 6 shows an example of a process flow that supports techniques for sidelink carrier aggregation with Mode 1 sidelink communications in accordance with one or more aspects of the present disclosure.

FIGS. 7 and 8 show block diagrams of devices that support techniques for sidelink carrier aggregation with Mode 1 sidelink communications in accordance with one or more aspects of the present disclosure.

FIG. 9 shows a block diagram of a communications manager that supports techniques for sidelink carrier aggregation with Mode 1 sidelink communications in accordance with one or more aspects of the present disclosure.

FIG. 10 shows a diagram of a system including a device that supports techniques for sidelink carrier aggregation with Mode 1 sidelink communications in accordance with one or more aspects of the present disclosure.

FIGS. 11 and 12 show block diagrams of devices that support techniques for sidelink carrier aggregation with Mode 1 sidelink communications in accordance with one or more aspects of the present disclosure.

FIG. 13 shows a block diagram of a communications manager that supports techniques for sidelink carrier aggregation with Mode 1 sidelink communications in accordance with one or more aspects of the present disclosure.

FIG. 14 shows a diagram of a system including a device that supports techniques for sidelink carrier aggregation with Mode 1 sidelink communications in accordance with one or more aspects of the present disclosure.

FIGS. 15 and 16 show flowcharts illustrating methods that support techniques for sidelink carrier aggregation with Mode 1 sidelink communications in accordance with one or more aspects of the present disclosure.

### DETAILED DESCRIPTION

In some wireless communications systems, a UE may support carrier aggregation (CA) with a network entity, in which the UE transmits and receives uplink (e.g., physical uplink shared channel (PUSCH)) and downlink (e.g., physical downlink shared channel (PDSCH)), respectively, via multiple carriers, which may be referred to as component carriers (CCs), between the UE and the network entity. In such cases, the UE may monitor downlink control channel candidates (e.g., physical downlink control channel (PDCCH) candidates) for one or more control messages each scheduling uplink or downlink, via the multiple carriers, according to one or more parameters. For example, the one or more parameters may include a quantity of downlink control channel candidates, a quantity of non-overlapping control channel elements (CCEs), or both. In such cases, the UE may support self-scheduling, in which a control message scheduling uplink or downlink via a given carrier is received via the same carrier, cross-carrier scheduling, in which all control messages, each scheduling uplink or downlink, are received via a scheduling carrier (e.g., regardless of a carrier associated with the respective uplink or downlink).

Additionally, in some wireless communications systems, the UE may support sidelink CA for Mode 2 sidelink communications. That is, the UE and a second UE may communicate via multiple sidelink carriers, where the UE transmits one or more control messages scheduling transmission of sidelink messages via the multiple sidelink carriers between the UEs. For example, the UE may transmit, to the second UE, a control message scheduling transmission of a sidelink message via a first sidelink carrier between the UE and the second UE. However, in some cases, the UEs may perform Mode 1 sidelink communications, in which a network entity schedules communications between the UEs. Such UEs may not support sidelink CA for Mode 1 sidelink communications.

Accordingly, techniques described herein may enable UEs to support sidelink CA for Mode 1 sidelink communications. More specifically, techniques described herein may define control signaling (e.g., transmitted by a network entity) that schedules sidelink communications between sidelink UEs in accordance with sidelink CA (e.g., via multiple sidelink carriers) and monitoring procedures for the sidelink UEs for receiving the control signaling. Further, techniques described herein may enable the sidelink UEs to receive the control signaling via one downlink carrier or multiple downlink carriers, and may enable the sidelink communications to be scheduled in accordance with cross-carrier scheduling, self-scheduling, or both.

In some cases, a network entity may transmit, via one or more downlink carriers of an access link, multiple control messages scheduling multiple sidelink messages via multiple sidelink carriers (e.g., between the first UE and the second UE). That is, each control message of the multiple control messages may schedule a respective sidelink message of the multiple sidelink messages on a respective sidelink carrier of the multiple sidelink carriers. In other words, the network entity may enable sidelink CA for Mode 1 sidelink communications based on scheduling multiple sidelink messages via multiple control messages. In some examples, the first UE may monitor up to a first quantity of downlink control channel candidates (e.g., physical downlink control channel candidates (PDCCH) candidates) and up to a second quantity of control channel elements (CCEs) for each sidelink carrier of the multiple sidelink carriers. In some other examples, the first UE may monitor, for each sidelink carrier of the multiple sidelink carriers, up to a respective subset of the first quantity of downlink control channel candidates and up to a respective subset of the second quantity of CCEs, where a sum of the respective subsets of the first quantity of downlink control channel candidates does not exceed the first quantity and a sum of the respective subsets of the second quantity of CCEs does not exceed the second quantity. As such, the first UE may enable sidelink CA for Mode 1 sidelink communications based on monitoring of downlink control channel candidates and non-overlapped CCEs from the network entity for scheduling of sidelink messages on multiple sidelink carriers.

Additionally, or alternatively, the network entity may transmit, via a single downlink carriers of the access link, a single control message scheduling the multiple sidelink messages via the multiple sidelink carriers. In such cases, the single control message may be associated with a downlink control information (DCI) format that supports scheduling of multiple sidelink carriers. For example, the DCI format may include one or more feedback timing indicators which the first UE may use to determine whether to transmit, to the network entity, a single uplink feedback conveying sidelink feedback for the multiple sidelink messages or multiple uplink feedback messages, where each uplink feedback message of the multiple uplink feedback messages conveys sidelink feedback for a respective sidelink message of the multiple sidelink messages. That is, the single control message may include a common feedback timing field indicating for the first UE to transmit the single uplink feedback message or may include multiple feedback timing fields indicating for the first UE to transmit the multiple uplink feedback messages. As such, the first UE may enable sidelink CA for Mode 1 sidelink communications based on transmitting feedback, to the network entity, for the multiple sidelink messages over the multiple sidelink carriers.

Aspects of the disclosure are initially described in the context of wireless communications systems. Aspects of the disclosure are then described in the context of scheduling configurations and a process flow. Aspects of the disclosure are further illustrated by and described with reference to apparatus diagrams, system diagrams, and flowcharts that relate to techniques for sidelink carrier aggregation with Mode 1 sidelink communications.

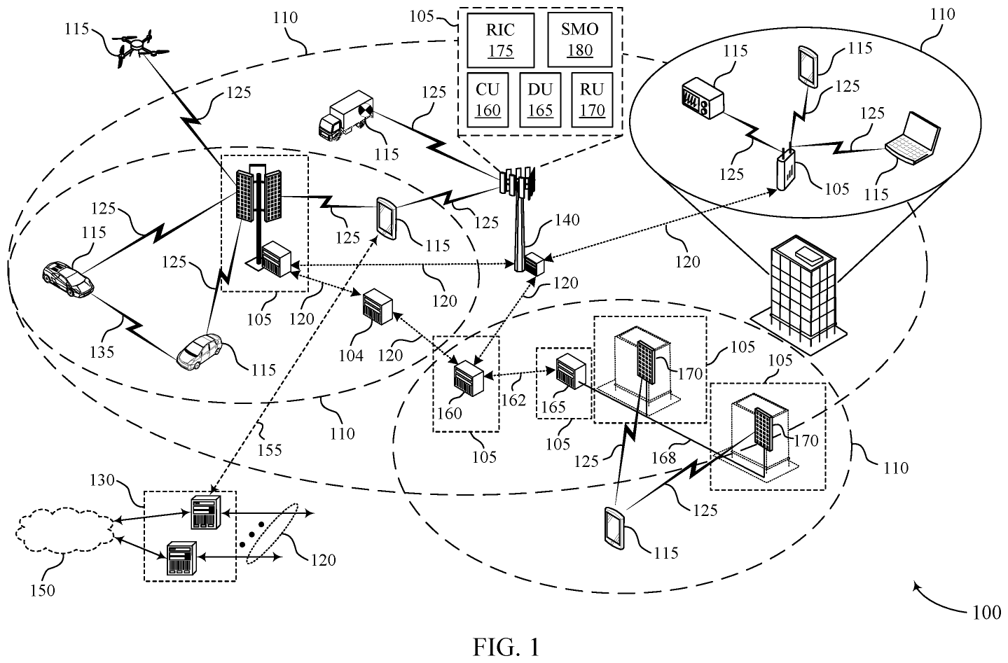

FIG. 1 shows an example of a wireless communications system 100 that supports techniques for sidelink carrier aggregation with Mode 1 sidelink communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for sidelink carrier aggregation with Mode 1 sidelink communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ−N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, the wireless communications system 200 may support sidelink CA for Mode 1 sidelink communications. In some cases, a network entity 105 may transmit, via one or more downlink carriers of an access link, multiple control messages scheduling multiple sidelink messages via multiple sidelink carriers between a first UE 115 and a second UE 115. That is, each control message of the multiple control messages may schedule a respective sidelink message of the multiple sidelink messages on a respective sidelink carrier of the multiple sidelink carriers. In some examples, the first UE 115 may monitor up to a first quantity of downlink control channel candidates (e.g., PDCCH candidates) and up to a second quantity of CCEs for each sidelink carrier of the multiple sidelink carriers. In some other examples, the first UE 115 may monitor, for each sidelink carrier of the multiple sidelink carriers, up to a respective subset of the first quantity of downlink control channel candidates and up to a respective subset of the second quantity of CCEs, where a sum of the respective subsets of the first quantity of downlink control channel candidates does not exceed the first quantity and a sum of the respective subsets of the second quantity of CCEs does not exceed the second quantity.

Additionally, or alternatively, the network entity 105 may transmit, via a single downlink carriers of the access link, a single control message scheduling the multiple sidelink messages via the multiple sidelink carriers. In such cases, the single control message may be associated with a DCI format that supports scheduling of multiple sidelink carriers. For example, the DCI format may include one or more feedback timing indicators which the first UE 115 may use to determine whether to transmit, to the network entity 105, a single uplink feedback conveying sidelink feedback for the multiple sidelink messages or multiple uplink feedback messages, where each uplink feedback message of the multiple uplink feedback messages conveys sidelink feedback for a respective sidelink message of the multiple sidelink messages. That is, the single control message may include a common feedback timing field indicating for the first UE 115 to transmit the single uplink feedback message or may include multiple feedback timing fields indicating for the first UE 115 to transmit the multiple uplink feedback messages.

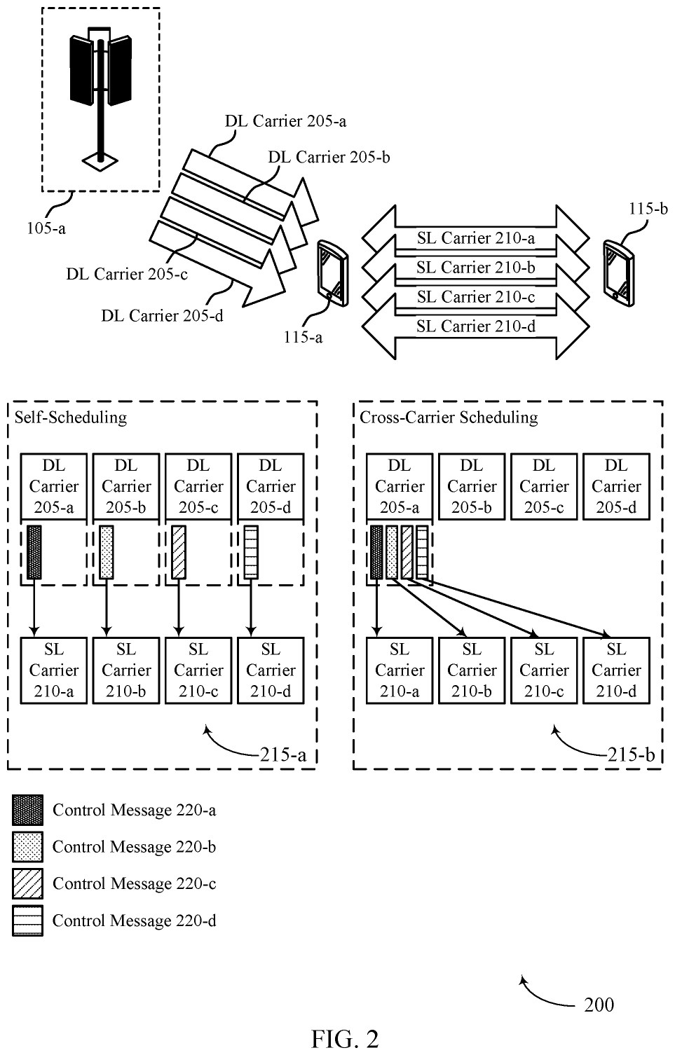

FIG. 2 shows an example of a wireless communications system 200 that supports techniques for sidelink carrier aggregation with Mode 1 sidelink communications in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a and a UE 115-b) and one or more network entities 105 (e.g., a network entity 105-a), which may be examples of the corresponding devices as described herein.

In some wireless communications systems, a UE 115 may support CA (e.g., downlink and uplink CA) with a network entity 105. In such cases, the UE 115 may transmit PUSCH, receive PDSCH, or both, via multiple carriers (e.g., CCs) between the UE 115 and the network entity 105. In such cases, the UE 115 may monitor one or more PDCCH candidates for each carrier (e.g., each cell) in a same carrier or different carriers. That is, the UE 115 may support (e.g., and be configured with) PDCCH monitoring for up to a first quantity, M, of PDCCH candidates and up to a second quantity, C, of non-overlapping CCEs per slot for each carrier. In such cases, M and C may depend on a subcarrier spacing (SCS) of an active downlink bandwidth part (BWP) of the downlink carrier(s) 205 where the UE 115 monitors a PDCCH for a control message 220 (e.g., DCI format). Additionally, M and C may be based on a table of values, such as Table 1 below.

TABLE 1
PDCCH Candidate and Non-Overlapping CCE Selection

| SCS | M | C |
|---|---|---|
| 15 kHz | 44 | 56 |
| 30 kHz | 36 | 56 |
| 60 kHz | 22 | 48 |
| 120 kHz | 20 | 32 |

In such cases, the table of values may be common for both self-scheduling and cross-carrier scheduling, as described in further detail below.

Additionally, for each scheduled carrier, the UE 115 may be configured to monitor no more than a third quantity of different DCI sizes (e.g., 4 different DCI sizes) and no more than a fourth quantity of different DCI sizes with cell specific radio access network temporary identifier (C-RTNI) (e.g., 3 different DCI sizes with C-RNTI). In such cases, if a quantity of DCI sizes (e.g., for multiple DCIs) that the UE 115 would be expected (e.g., required) to monitor according to a configuration of the UE 115 (e.g., radio resource control (RRC) configuration) exceeds the third quantity, the fourth quantity, or both, the UE 115 may perform a DCI size alignment procedure. In such cases the UE 115 may size-match some of the multiple DCIs by zero-padding or truncating the DCIs, such that a result of the size match provides no more than the third quantity of different DCI sizes and the fourth quantity different DCI sizes with C-RNTI.

For example, the UE 115 may be configured to monitor DCI format 3_0 on a carrier and a total quantity of DCI sizes of DCI formats configured for the UE 115 to monitor for the downlink carrier 205 and the DCI format 30 may be greater than the third quantity (e.g., 4), such that the UE 115 may append zeros to the DCI format 3_0 until a payload size of the DCI format 30 equals that of a smallest DCI format configured for the UE 115 to monitor for the downlink carrier 205 that is larger than the DCI format 3_0.

Additionally, the UE 115 may support self-scheduling, cross-carrier scheduling, or both. According to self-scheduling, a PDCCH (e.g., control message 220) for a DCI format and a scheduled PDSCH or PUSCH associated with the PDCCH are on a same carrier. That is, the UE 115 may receive, on a first carrier, a PDCCH that schedules PDSCH or PUSCH, where the PDSCH or the PUSCH is scheduled on the first carrier. According to cross-carrier scheduling, a PDCCH for a DCI format and a scheduled PDSCH or PUSCH associated with the PDCCH may be on different carriers. That is, the UE 115 may receive, on the first carrier (e.g., a serving carrier) a PDCCH that schedules PDSCH or PUSCH, where the PDSCH or the PUSCH is scheduled on a second carrier (e.g., different than the first carrier). In either case, the UE 115 may monitor up to M PDCCH candidates and up to C non-overlapping CCEs for each scheduled carrier.

In some examples of cross-carrier scheduling, the UE 115 may monitor PDCCH candidates for different scheduled carriers on a scheduling carrier. That is, all PDCCH may be received via the scheduling carrier, regardless of what carrier a PDCCH schedules PDSCH or PUSCH. In such cases, different PDCCH candidates for different scheduled carriers may be identified on different sets of CCEs, where different scheduled downlink cells are associated with different values of n_{CI}. That is, for a search space set, s, associated with a control resource set (CORESET), p, CCE indexes for aggregation level, L, corresponding to PDCCH candidate, m_{s,n}_{_{CI}}, of the search space set in slot, n_{s,f}^{μ}, for an active downlink BWP of a serving carrier (e.g., cell) corresponding to a carrier indicator field value n_{CI} are given according to Equation 1:

$$L \cdot \{ ( {y}_{p , {n}_{s f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ {N}_{C C E , p} / L ⌋ \} + i \qquad ( 1 )$$

where

$${Y}_{p , {n}_{s , f}^{μ}}$$

may represent ______, N_{CCE,p} may represent a quantity of CCEs numbered from 0 to N_{CCE,p}−1 in CORESET, p, M_{s,max}^{(L)} may represent a quantity of PDCCH candidates the UE 115 is configured to monitor for the aggregation level, L, of the search space set, s, for a serving carrier corresponding to n_{CI}, and i may represent an integer value from 0 to L−1.

Additionally, some UEs 115 may support sidelink communications. In some cases, the UEs 115 may support Mode 2 sidelink communications, in which a first UE 115 schedules communications with a second UE 115, independent of a network entity 105. In such cases, the first UE 115 and the second UE 115 may support sidelink CA for Mode 2 sidelink communications. In some other cases, as depicted in FIG. 2, the UEs 115, may support Mode 1 sidelink communications in which a network entity 105, such as the network entity 105-a, schedules sidelink communications between a first UE 115, such as the UE 115-a, and a second UE 115, such as the UE 115-b. In such cases, conventional techniques may not provide mechanisms for sidelink CA for Mode 1 sidelink communications.

Accordingly, techniques described herein may enable sidelink CA (e.g., inter-band sidelink CA) for Mode 1 (e.g., random access Mode 1) sidelink communications. In some cases, sidelink CA with Mode 1 sidelink communications for a quantity, N, of sidelink carriers 210 (e.g., SL carriers 210) may be enabled based on the UE 115-a supporting CA with the network entity 105-a with at least N downlink carriers 205 (e.g., DL carriers 205). For example, the UE 115-a may support, with the UE 115-b, a sidelink carrier 210-a, a sidelink carrier 210-b, a sidelink carrier 210-c, and a sidelink carrier 210-d, such that sidelink CA is enable based on the UE 115-a supporting, with the network entity 105-a, a downlink carrier 205-a, a downlink carrier 205-b, a downlink carrier 205-c, and a downlink carrier 205-d. In such cases, a PDCCH blind decoding capability of the UE 115-a for CA (e.g., uplink/downlink CA) with the network entity 105-a may be re-used for sidelink CA with Mode 1 sidelink communications. In other words, the UE 115-a may support (e.g., and be configured with) PDCCH monitoring for up to a first quantity, M, of PDCCH candidates and up to a second quantity, C, of non-overlapped CCEs per slot for a DCI format scheduling a sidelink message (e.g., DCI format 3_0) on each of the N sidelink carriers 210. For example, the UE 115-a may monitor up to M PDCCH candidates and up to C non-overlapped CCEs on each of the sidelink carrier 210-a, the sidelink carrier 210-b, the sidelink carrier 210-c, and the sidelink carrier 210-d. In such cases, M and C may depend on a SCS of an active downlink BWP of the downlink carrier(s) 205 where the UE 115 monitors a PDCCH for a DCI format (e.g., a control message 220) and may be based on a table of values, such as Table 1, above. Additionally, the UE 115-a may support PDCCH monitoring for up to M PDCCH candidates and up to C of non-overlapped CCEs for self-scheduling (e.g., where each of a control message 220-a, a control message 220-b, a control message 220-c, and a control message 220-d are received on respective downlink carriers 205), as depicted in scheduling scheme 215-a, and for cross-carrier scheduling (e.g., where the control message 220-a, the control message 220-b, the control message 220-c, and the control message 220-d are received on a same downlink carrier 205), as depicted in scheduling scheme 215-b.

Additionally, the up to M PDCCH candidates and the up to C of non-overlapped CCEs on each of the N sidelink carriers 210 may be counted on one of the downlink carriers 205 (e.g., downlink cells). In some cases, if the UE 115-a may be configured with Mode 1 sidelink communications on a serving carrier that supports downlink (e.g., a downlink carrier 205), the UE 115-a may count the up to M PDCCH candidates and the up to C of non-overlapped CCEs for a control message 220 (e.g., associated with the DCI format scheduling sidelink messages, DCI format 3_0) on the serving carrier. In some other cases, the downlink carrier 205 over which to count the up to M PDCCH candidates and the up to C of non-overlapped CCEs may be based on a configuration of the UE 115-a (e.g., based on RRC configuration). For example, for a control message 220, such as the control message 220-a, on a first sidelink carrier 210, such as the sidelink carrier 210-a, the UE 115-a may be configured to count one of the downlink carriers 205 for the up to M PDCCH candidates and the up to C of non-overlapped CCEs for the control message 220-a (e.g., associated with the DCI format scheduling sidelink messages). In some examples, a downlink carrier 205 that is used to count for a sidelink carrier 210 may not be the same carrier. For example, the UE 115-a may support four downlink carriers 205 and two sidelink carriers 210. As such, the up to M PDCCH candidates and the up to C of non-overlapped CCEs for each of the 2 sidelink carriers 210 may be counted on one of the four downlink carriers 205, where the downlink carrier 205 to count on is configured via control signaling for each of the two sidelink carriers 210. In some cases, for a downlink carrier 205 where the UE 115-a is configured to count a quantity of PDCCH candidates and a quantity non-overlapped CCWs per slot for a control message 220, a total quantity of PDCCH candidates and a total quantity non-overlapped CCEs per slot for DCI formats (e.g., control messages 220), including the DCI format scheduling sidelink messages on a sidelink carrier 210, may not exceed M and C, respectively.

In some cases, for a downlink carrier 205 where the UE 115-a is configured to count a quantity of PDCCH candidates and a quantity non-overlapped CCEs per slot for the DCI format scheduling sidelink messages on a sidelink carrier 210, a total quantity of different DCI sizes configured for the UE 115-a to monitor (e.g., including the DCI format scheduling sidelink messages on the sidelink carrier 210 configured to be associated with the downlink carrier 205) may satisfy (e.g., not exceed) a first threshold quantity (e.g., 4). Similarly, a total quantity of different DCI sized with C-RNTI configured for the UE 115-a to monitor may satisfy (e.g., not exceed) a second threshold quantity (e.g., 3). In some cases, if a quantity of DCI sizes (e.g., for multiple DCIs) that the UE 115 would be expected (e.g., required) to monitor according to a configuration of the UE 115-a (e.g., RRC configuration) exceeds the first threshold quantity, the second threshold quantity, or both, the UE 115 may perform a DCI size alignment procedure. In such cases the UE 115-a may size-match some of the multiple DCIs (e.g., control messages 220) by zero-padding or truncating the DCIs, such that a result of the size match provides no more than the first threshold quantity of different DCI sizes and the second threshold quantity of different DCI sizes with C-RNTI.

For example, the UE 115-a may be configured to monitor DCI format 3_0 on a sidelink carrier 210 counted on a downlink carrier 205 and a total quantity of DCI sizes of DCI formats configured for the UE 115 to monitor for the downlink carrier 205 and the DCI format 3_0 for the sidelink carrier 210 may be greater than the first threshold quantity (e.g., 4), such that the UE 115-a may append zeros to the DCI format 3_0 until a payload size of the DCI format 30 equals that of a smallest DCI format configured for the UE 115 to monitor for the downlink carrier 205 that is larger than the DCI format 3_0.

Additionally, in some cases, a value of n_{CI}, as described with reference to Equation 1, for the DCI format scheduling sidelink messages on a sidelink carrier 210 may be the same as a value of n_{CI} for a DCI format for a downlink carrier 205 associated with the sidelink carrier 210. In other words, the UE 115-a may monitor PDCCH for DCI formats for the downlink carrier 205 and for the sidelink carrier 210 using a same value of n_{CI}. However, different downlink carriers 205 with different sidelink carriers 210 may use different values of n_{CI}.

As used herein, “satisfying a threshold” may, depending on the context, refer to a value being greater than the threshold, greater than or equal to the threshold, less than the threshold, less than or equal to the threshold, equal to the threshold, not equal to the threshold, or the like

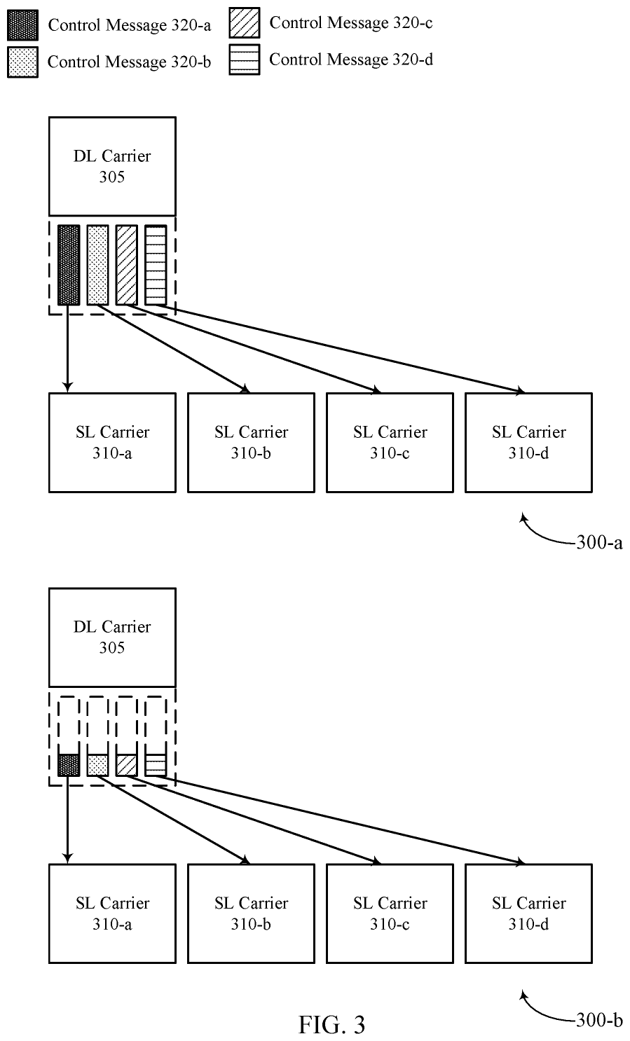

FIG. 3 shows examples of scheduling configurations 300 (e.g., a scheduling configuration 300-a and a scheduling configuration 300-b) that supports techniques for sidelink carrier aggregation with Mode 1 sidelink communications in accordance with one or more aspects of the present disclosure. In some cases, the scheduling configurations 300 may implement or be implemented by aspects of the wireless communications system 100, the wireless communications system 200, or both. For example, the scheduling configurations 300 may be implemented by one or more UEs 115 and one or more network entities 105, which may be examples of the corresponding devices as described herein.

In some examples, a UE 115 may support Mode 1 sidelink communications for sidelink CA using a single serving network entity 105 (e.g., Uu serving cell) associated with a single downlink carrier 305. In such cases, for sidelink scheduling, the network entity 105 may transmit one or more control messages 320 (e.g., DCI format), such as a control message 320-a, a control message 320-b, a control message 320-c, and a control message 320-d, on the downlink carrier 305 (e.g., DL carrier 305) for scheduling of sidelink messages on multiple sidelink carriers 310 (e.g., SL carriers 310), such as a sidelink carrier 310-a, a sidelink carrier 310-b, a sidelink carrier 310-c, and a sidelink carrier 310-d, respectively. In such cases, the UE 115 may transmit sidelink feedback (e.g., HARQ-ACK) of the multiple sidelink carriers on a PUCCH or PUSCH of an uplink carrier. In other words, downlink and uplink of a single network entity 105 may support Mode 1 sidelink communications of the multiple sidelink carriers 310. In such cases, downlink and uplink CA may be configured (e.g., enabled) separately from sidelink CA (e.g., sidelink CA with Mode 1 sidelink communications may not require downlink CA or increase complexity or power consumption).

As such, sidelink CA for Mode 1 sidelink communications for a quantity, N, of sidelink carriers 310 may be enabled when the UE 115-a is configured with a quantity, L, of downlink carriers 305 that is less than the first quantity (e.g., L<N). In such cases, the UE 115 may support a reduced quantity of PDCCH candidates and a reduced quantity of non-overlapped CCEs per slot for control messages 320 (e.g., control messages scheduling sidelink messages, DCI format 3_0) on each of the N sidelink carriers 310. In other words, rather than supporting up to M PDCCH candidates and up to C non-overlapped CCEs per slot for control messages 320, as depicted in the scheduling configuration 300-a, the UE 115 may support a reduced quantity of PDCCH candidates and a reduced quantity of non-overlapped CCEs relative to the scheduling configuration 300-a, as depicted in the scheduling configuration 300-b. In such cases, M and C may depend on a SCS of an active downlink BWP of the downlink carrier 305 where the UE 115 monitors a PDCCH for a control message 320, as described further with reference to FIG. 2.

In some cases, for each scheduled sidelink carrier 310, the UE 115 may identify a set of up to M×(L/N) PDCCH candidates and a set of up to C×(L/N) non-overlapped CCEs per slot for control messages 320 (e.g., DCI formats scheduling sidelink messages, DCI format 3_0). For example, in the context of the scheduling configuration 300-a, the quantity, L, of downlink carriers 305, may be 1 and the quantity, N, of sidelink carriers 310 may be 4, such that for each sidelink carrier 310, the UE 115 may monitor up to M×(¼) PDCCH candidates and a set of up to C×(¼) non-overlapped CCEs per slot. In some other cases, for each scheduled sidelink carrier 310, the UE 115 may receive a configuration message (e.g., or be pre-configured) indicating a respective quantity of PDDCH candidates and a respective quantity of non-overlapped CCES the UE 115 may process per slot. That is, each scheduled sidelink carrier 310 may be associated with a different quantity of PDCCH candidates and a different quantity of non-overlapped CCEs, where the different quantities are based on a configuration of the UE 115. However, in either case, a total quantity of PDCCH candidates and a total quantity of non-overlapped CCEs per slot across all sidelink carriers 310 may not exceed M and C, respectively.

Additionally, a DCI size of each control message 320 (e.g., DCI format scheduling sidelink messages on different sidelink carriers 310) on a same downlink carrier 305 (e.g., cell) may be aligned. For example, if the UE 115 monitors for a control message 320 (e.g., DCI format 3_0) on a downlink carrier 305 for more than one sidelink carrier 310, zeros may be appended to one or more control messages 320 until a payload size of each of the one or more the control messages 320 for the sidelink carriers 310 monitored on the same downlink carrier 305 are matched (e.g., are equal). Thus, the UE 115 may execute DCI size alignment between the control messages 320 (e.g., the DCI format 3_0 and other DCI formats). Additionally, a value of n_{CI}, as described with reference to Equation 1, for the control messages 320 may be different. That is, the UE 115 may identify on which CCEs the UE 115 may monitor PDCCH candidates for which sidelink carrier 310 based on a respective value of n_{CI}.

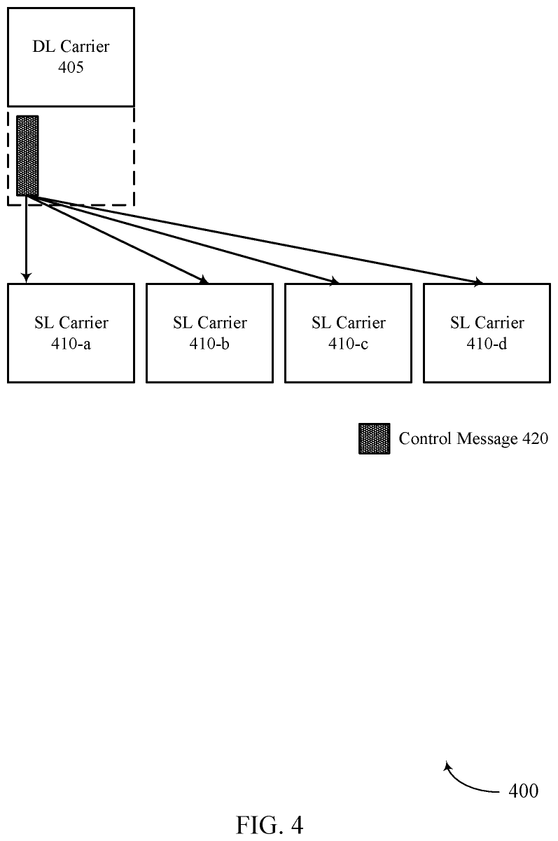

FIG. 4 shows an example of a scheduling configuration 400 that supports techniques for sidelink carrier aggregation with Mode 1 sidelink communications in accordance with one or more aspects of the present disclosure. In some cases, the scheduling configuration 400 may implement or be implemented by aspects of the wireless communications system 100, the wireless communications system 200, the scheduling configurations 300, or any combination thereof. For example, the scheduling configuration 400 may be implemented by one or more UEs 115 and one or more network entities 105, which may be examples of the corresponding devices as described herein.

As described previously, in some examples, a UE 115 may support Mode 1 sidelink communications for sidelink CA using a single serving network entity 105 (e.g., Uu serving cell). Additionally, in some cases, the serving network entity 105 may transmit, via a single downlink carrier 405 (e.g., DL carrier 405), a single control message 420 scheduling sidelink messages on one or more sidelink carriers 410 (e.g., SL carriers 410). In such cases, the control message 420 may be associated with a DCI format (e.g., DCI format 3_2) that supports scheduling of one or more sidelink carriers 410. That is, the UE 115 may be configured to monitor PDCCH for the control message 420 (e.g., new DCI format 3_2) for a set of sidelink carriers 310, where the DCI format of the control message 420 supports (e.g., enables) scheduling sidelink messages (e.g., transmissions) on one or more sidelink carriers 410. For example, the control message 420 may schedule a first sidelink message on a sidelink carrier 410-a, a second sidelink message on a sidelink carrier 410-b, a third sidelink message on a sidelink carrier 410-c, and a fourth sidelink message on a sidelink carrier 410-d. In such cases, each detected control message 420 may indicate to the UE 115 which of the sidelink carriers 410 are scheduled by the control message 420. For example, the DCI format of the control message 420 may include one or more fields for scheduling one or more sidelink carriers 410 in a set of sidelink carriers 410 (e.g., the sidelink carrier 410-a, the sidelink carrier 410-b, the sidelink carrier 410-c, and the sidelink carrier 410-d). In such cases, the network entity 105 may configure (e.g., indicate via configuration information) the set of sidelink carriers 410 (e.g., via RRC signaling). The set of sidelink carriers may similarly be referred to as the configured set of sidelink carriers 410.

For example, a first DCI format (e.g., of a control message 420) that does not support scheduling of one or more sidelink carriers 410 (e.g., DCI format 3_0) may have fields according to Table 2 below:

TABLE 2
First DCI Format (e.g., DCI Format 3_0) Fields

| Field | Number of Bits |
|---|---|
| Resource Pool Index | [log₂I] (up to 3 bits) |
| Time Gap | 3 |
| HARQ Process | 4 |
| New Data Indicator | 1 |
| Lowest Index of Sub- | [log₂ N_{subCh}^{SL}] (up to 5 bits) |
| Channel | |
| Frequency Domain Resource Allocation | $[ {log}_{2} ( \frac{{N}_{subCh}^{SL} ( {N}_{subCh}^{SL} + 1 )}{2} ) ] ( up to 9 bits ) or$ $[ {log}_{2} ( \frac{{N}_{subCh}^{SL} ( {N}_{subCh}^{SL} + 1 ) ( 2 {N}_{subCh}^{SL} + 1 )}{2} ) ] ( up to 15 bits )$ |
| Time Domain Resource | 5 or 9 |
| Allocation | |
| Physical Sidelink | [log₂ N_{fb}_timing] (up to 3 bits) |
| Feedback Channel | |
| (PSFCH)-to-HARQ | |
| Feedback Timing | |
| Physical Uplink Control | 3 |
| Channel (PUCCH) | |
| Resource | |
| Configuration Index | 0 or 3 |
| Counter Sidelink | 2 |
| Assignment Index | |
| Padding Bits, if needed | — |
| Total (Excluding 24 bit | Min: 19 bits, Max: 52 bits |
| cyclic redundancy check) | |

Conversely, a second DCI format (e.g., of a control message 420) that supports scheduling of one or more sidelink carriers 410 (e.g., DCI format 3_2) may have fields according to Table 3 below:

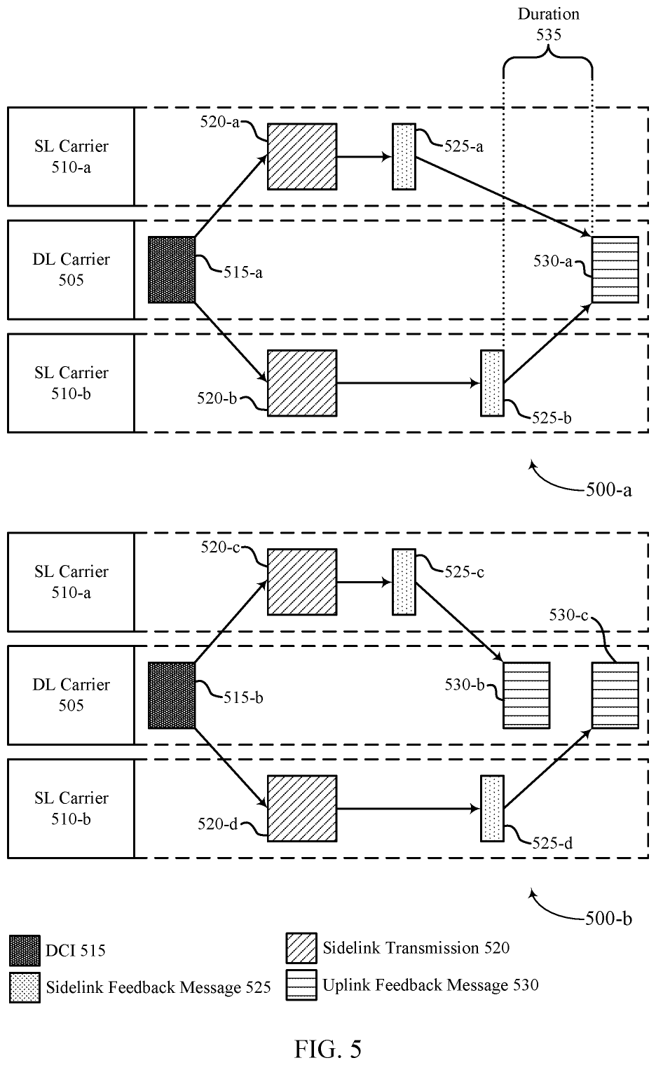

TABLE 3
Second DCI Format (e.g., DCI Format 3_2) Fields

| Field | Number of Bits |
|---|---|
| Resource Pool Index | Multiple [log₂I] (up to 3 bits) for multiple sidelink |
| | carriers 410 |
| Time Gap | Multiple 3 bits for multiple sidelink carriers 410, or |
| | single 3 bits for joint indication for multiple sidelink |
| | carriers 410 |
| HARQ Process | Multiple 4 bits for multiple sidelink carriers 410 |
| New Data Indicator | Multiple 1 bits for multiple sidelink carriers 410 |
| Lowest Index of Sub- | Multiple [log₂ N_{subCh}^{SL}] (up to 5 bits) for multiple |
| Channel | sidelink carriers 410 |
| Frequency Domain Resource Allocation | Multiple of the following for multiple sidelink carriers $410 : [ {log}_{2} ( \frac{{N}_{subCh}^{SL} ( {N}_{subCh}^{SL} + 1 )}{2} ) ] ( up to 9 bits ) or$ $[ {log}_{2} ( \frac{{N}_{subCh}^{SL} ( {N}_{subCh}^{SL} + 1 ) ( 2 {N}_{subCh}^{SL} + 1 )}{2} ) ] ( up to 15 bits )$ |
| Time Domain Resource | Multiple 5 or 9 bits, or single 5 or 9 bits for joint |
| Allocation | indication for multiple sidelink carriers 410 |
| PSFCH-to-HARQ | Described with reference to FIG. 5 |
| Feedback Timing | |
| PUCCH Resource | Described with reference to FIG. 5 |
| Configuration Index | 0 bits, or multiple 3 bits, or single 3 bits for joint |
| | indication for multiple sidelink carriers 410 |
| Counter Sidelink | Described with reference to FIG. 5 |
| Assignment Index | |
| Padding Bits, if needed | — |
| Total (Excluding 24 bit | Depends on a quantity of sidelink carriers 410 |
| cyclic redundancy check) | |

As such, the UE 115 may be configured to monitor PDCCH for a control message 420 of the second DCI format for one or more sidelink carriers 410 of the configured set of sidelink carriers 410 (e.g., the sidelink carrier 410-a, the sidelink carrier 410-b, the sidelink carrier 410-c, and the sidelink carrier 410-d) on the downlink carrier 405 (e.g., downlink cell). In such cases, the UE 115 may identify fields, field sizes, or both, of the second DCI format (e.g., control message 420) for the one or more sidelink carriers 410 based on the configured set of sidelink carriers 410.

Additionally, the control message 420 may request that the UE 115 report feedback (e.g., sidelink HARQ-ACK) received from one or more other UEs 115, which may be referred to as target UEs 115, where the feedback is in response to the one or more sidelink messages scheduled via the one or more sidelink carriers 410 based on the control message 420. In such cases, the UE 115 may report, to the network entity 105, the feedback received from the one or more target UEs 115 via a single uplink feedback message (e.g., multiplexed on a common uplink channel) or via multiple uplink feedback messages (e.g., independently transmitted using different uplink channels). In such cases, the UE 115 may determine whether to transmit the single uplink feedback message or the multiple uplink feedback messages, and how to transmit the single uplink feedback message or the multiple uplink feedback messages, based on one or more fields of the second DCI format (e.g., the PSFCH-to-HARQ feedback timing field, the PUCCH resource field, and the counter sidelink assignment field), as described with reference to FIG. 5.

FIG. 5 shows examples of timing diagrams 500 (e.g., a timing diagram 500-a and a timing diagram 500-b) that supports techniques for sidelink carrier aggregation with Mode 1 sidelink communications in accordance with one or more aspects of the present disclosure. In some cases, the timing diagrams 500 may implement or be implemented by aspects of the wireless communications system 100, the wireless communications system 200, the scheduling configurations 300, the scheduling configuration 400, or any combination thereof. For example, timing diagrams 500 may be implemented by one or more UEs 115 and one or more network entities 105, which may be examples of the corresponding devices as described herein.

As described with reference to FIG. 4, a first UE 115 may receive, from a network entity 105 via a downlink carrier 505 of an access link, a single control message, such as a DCI 515, scheduling one or more sidelink transmissions 520 (e.g., sidelink messages) on one or more sidelink carriers 510, such as a sidelink carrier 510-a (e.g., CC1) and a sidelink carrier 510-b (e.g., CC2). In such cases, the DCI 515 (e.g., DCI format 3_2) may request that the UE 115 report sidelink feedback (e.g., sidelink HARQ-ACK) received from one or more other UEs 115, which may be referred to as second UEs 115, to the network entity 105, where the sidelink feedback is in response to the one or more sidelink transmissions 520 scheduled on the one or more sidelink carriers 510 based on the DCI 515.

In some examples, the first UE 115 may report, to the network entity 105, the sidelink feedback received from the one or more second UEs 115 via a single uplink feedback message 530, such as an uplink feedback message 530-a (e.g., sidelink HARQ-ACK report for multi-carrier sidelink transmission 520 scheduled by the DCI 515 may be reported using a common PUCCH or PUSCH). For example, as depicted in the timing diagram 500-a, the network entity 105 may transmit, to the second UE 115 via the downlink carrier 505, a DCI 515-a (e.g., DCI format 3_2) scheduling a sidelink transmission 520-a on the sidelink carrier 510-a and a sidelink transmission 520-b on the sidelink carrier 510-b. In such cases, the DCI 515-a may include a common feedback timing field (e.g., PSFCH-to-HARQ feedback timing field).

In some cases, the common feedback timing field may indicate a value of feedback timing (e.g., HARQ feedback timing), where a reference for a timing determination is the end of a last sidelink feedback message 525 (e.g., PSFCH) among multiple sidelink feedback messages 525 in response to the sidelink transmissions 520 scheduled by the DCI 515-a. For example, as depicted in the timing diagram 500-a, the first UE 115 may perform the sidelink transmission 520-a on the sidelink carrier 510-a and the sidelink transmission 520-b on the sidelink carrier 510-b. Additionally, the first UE 115 may receive, from one or more second UEs 115, a sidelink feedback message 525-a (e.g., PSFCH) on the sidelink carrier 510-a in response to the sidelink transmission 520-a and a sidelink feedback message 525-b (e.g., PSFCH) on the sidelink carrier 510-b in response to the sidelink transmission 520-b, where the sidelink feedback message 525-b is received after the sidelink feedback message 525-a (e.g., is a last sidelink feedback message 525). As such, based on the value of the feedback timing, the first UE 115 may wait a duration 535 (e.g., gap) after the sidelink feedback message 525-b before transmitting an uplink feedback message 530 (e.g., common PUCCH or PUSCH) including first sidelink feedback from the sidelink feedback message 525-a and second sidelink feedback from the sidelink feedback message 525-b.

In some other cases, the reference for the timing determination may be the end of a last sidelink transmission 520 (e.g., physical sidelink shared channel (PSSCH)) among the multiple sidelink transmissions 520 (e.g., the sidelink transmission 520-a and the sidelink transmission 520-b) scheduled by the DCI 515-a. In some other cases, the reference for the timing determination may be the end of a last sidelink feedback message 525 or a last sidelink transmission 520 of the multiple sidelink feedback messages 525 or the multiple sidelink transmission 520.

Additionally, or alternatively, the first UE 115 may report, to the network entity 105, the sidelink feedback received from the one or more second UEs 115 via multiple uplink feedback messages 530, such as an uplink feedback message 530-b and an uplink feedback message 530-c (e.g., sidelink HARQ-ACK report for multi-carrier sidelink transmission 520 scheduled by the DCI 515 may be reported using different PUCCHs or PUSCHs). For example, as depicted in the timing diagram 500-b, the network entity 105 may transmit, to the second UE 115 via the downlink carrier 505, a DCI 515-b (e.g., DCI format 3_2) scheduling a sidelink transmission 520-c on the sidelink carrier 510-a and a sidelink transmission 520-d on the sidelink carrier 510-b. In such cases, the DCI 515-b may include multiple feedback timing fields (e.g., PSFCH-to-HARQ feedback timing fields). As such, the first UE 115 may use each of the multiple feedback timing fields to identify multiple feedback occasions (e.g., PUCCH occasions or PUSCH occasions) to convey, to the network entity 105, sidelink feedback messages 525 (e.g., a sidelink feedback message 525-c and a sidelink feedback message 525-d) received in response to the sidelink transmission 520-c and the sidelink transmission 520-d (e.g., via multiple uplink feedback messages 530).

Additionally, the DCI 515-b may include multiple (e.g., separate) uplink resource indication fields (e.g., PUCCH resource indication fields) and multiple counter assignment index fields. In such cases, each of the multiple uplink resource indication fields and the multiple counter assignment index fields may apply to a respective uplink feedback message 530 of the multiple uplink feedback messages 530 carrying sidelink feedback (e.g., reported via sidelink feedback messages 525) for the sidelink transmissions 520 scheduled by the DCI 515-b. In other words, the DCI 515-b may include a first feedback timing field (e.g., value), a first uplink resource indication field (e.g., value), and a first counter assignment index field (e.g., value) associated with the uplink feedback message 530-b (e.g., including first sidelink feedback from the sidelink feedback message 525-c) and a second feedback timing field, a second uplink resource indication field, and a second counter assignment index field associated with the uplink feedback message 530-c (e.g., including second sidelink feedback from the sidelink feedback message 525-d).

As such, the first UE 115 may transmit, to the network entity 105 via the access link, the uplink feedback message 530-b including the first sidelink feedback (e.g., from the sidelink feedback message 525-c responsive to the sidelink transmission 520-c) and the uplink feedback message 530-c including the second sidelink feedback (e.g., from the sidelink feedback message 525-d responsive to the sidelink transmission 520-d). In such cases, the UE 115 may transmit the uplink feedback message 530-b according to the first feedback timing field, the first uplink resource indication field, and the first counter assignment index field, and may transmit the uplink feedback message 530-c according to the second feedback timing field, the second uplink resource indication field, and the second counter assignment index field.

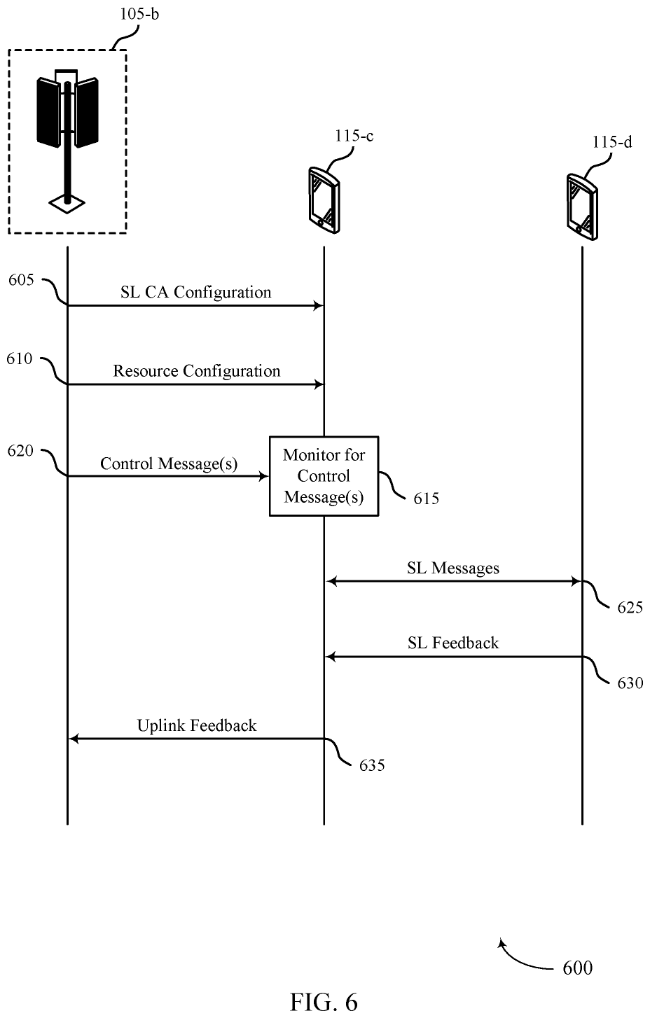

FIG. 6 shows an example of a process flow 600 that supports techniques for sidelink carrier aggregation with Mode 1 sidelink communications in accordance with one or more aspects of the present disclosure. In some cases, the process flow 600 may implement or be implemented by aspects of the wireless communications system 100, the wireless communications system 200, the scheduling configurations 300, the scheduling configuration 400, the timing diagrams 500, or any combination thereof. For example, the wireless communications system 200 may include one or more UEs 115 (e.g., a UE 115-c and a UE 115-d) and one or more network entities 105 (e.g., a network entity 105-b), which may be examples of the corresponding devices as described herein.

At 605, the UE 115-c may receive, from the network entity 105-b via an access link, a first control message enabling sidelink CA between the UE 115-c and the UE 115-d. That is, the first control message may activate sidelink CA between the UE 115-c and the UE 115-d, may indicate configuration information (e.g., one or more parameters) associated with sidelink CA between the UE 115-c and the UE 115-d, or both. In such cases, the sidelink CA may be associated with at least multiple sidelink carriers for sidelink communications between the UE 115-c and the UE 115-d.

In some cases, at 610, the UE 115-c may receive, from the network entity 105-b via an access link, a second control message (e.g., resource configuration) indicating a respective quantity of downlink control channel candidates (e.g., PDCCH candidates) and a respective quantity of non-overlapping CCEs for the UE 115-c to monitor for each third control message of one or more third control messages. In some cases, the respective quantity of downlink control channel candidates and the respective quantity of non-overlapping CCEs for each third control message may be different. Additionally, a sum of the respective quantities of downlink control channel candidates and the respective quantities of non-overlapping CCEs for each third control message may be up to first threshold quantity of downlink control channel candidates and a second threshold quantity of non-overlapping CCEs, respectively.

In some cases, at 615, the UE 115-c may monitor for each third control message of the one or more third control messages and, at 620, the network entity 105-b may transmit, to the UE 115-c via the access link, the one or more third control messages scheduling transmission of multiple sidelink messages (e.g., sidelink transmissions) over the multiple sidelink carriers based on the first control message.

In some cases, the network entity 105-b may transmit, via one or more downlink carriers of the access link, multiple third control messages, where each third control message of the multiple third control messages schedules a respective sidelink message of the multiple sidelink messages over a respective sidelink carrier of the multiple sidelink carriers. In such cases, the UE 115-c may monitor, for each third control message of the multiple third control messages, up to the first threshold quantity of downlink control channel candidates and up to the second threshold quantity of non-overlapping CCEs for the multiple third control messages. In such cases, the first threshold quantity of downlink control channel candidates and the second threshold quantity of non-overlapping CCEs may be based on an SCS of an active downlink BWP associated with the network entity 105-b. Alternatively, the UE 115-c may monitor, for each third control message of the multiple third control messages, up to a first portion of the first threshold quantity of downlink control channel candidates and up to a second portion of the second threshold quantity of non-overlapping CCEs for the multiple third control message. In some examples, both a quantity of downlink control channel candidates in the first portion and a quantity of non-overlapping CCEs in the second portion may be the same for each third control message. In some other examples, the first portion and the second portion may be based on the second control message.

In some other cases, the network entity 105-b may transmit, via a single downlink carrier of the access link, a single third control messages, where the single third control message schedules the multiple sidelink messages over the multiple sidelink carriers. In some examples, the single downlink carrier may be indicated as a scheduling downlink carrier via the first control message. In some examples, the single second control message may indicate multiple sets of parameters for the multiple sidelink messages. For example, a first set of parameters of the multiple sets of parameters includes a resource pool index, a time gap, a HARQ process, a new data indicator, a lowest index of sub-channel, a frequency domain resource assignment, a time domain resource assignment, a feedback timing, an uplink control channel resource, a configuration index, a counter sidelink assignment index, or any combination thereof.

As such, at 625, the UE 115-c may communicate the multiple sidelink messages via the multiple sidelink carriers associated with the sidelink carrier aggregation based on the one or more third control messages and, at 630, may receive, from the UE 115-d via one or more sidelink carriers of the multiple sidelink carriers, multiple sidelink feedback messages indicating feedback for the multiple sidelink messages.

In some cases, at 635, the UE 115-c may transmit, to the network entity 105-b via the access link, the feedback for the multiple sidelink messages. In some examples, the UE 115-c may transmit a single feedback message indicating the feedback for the multiple sidelink messages. In such cases, the UE 115-c may transmit the single feedback message a first threshold time duration after receipt of a last sidelink feedback message of the multiple sidelink feedback messages. In some other examples, the UE 115-c may transmit multiple feedback messages for the multiple sidelink messages, where each feedback message of the multiple feedback messages indicates feedback for a respective sidelink message of the multiple sidelink messages. In such cases, the UE 115-c may transmit each feedback message a second threshold time duration (e.g., the same as or different than the first threshold time duration) after a respective sidelink feedback message of the multiple sidelink feedback messages.

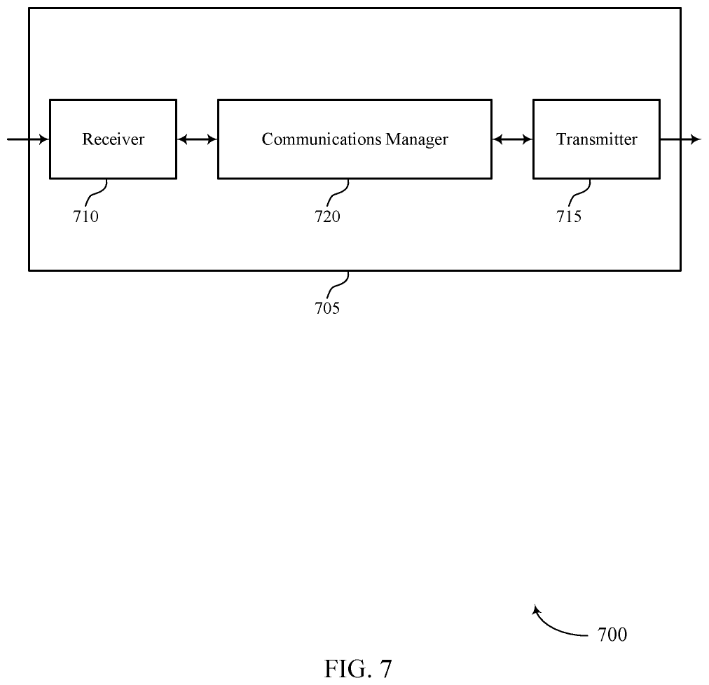

FIG. 7 shows a block diagram 700 of a device 705 that supports techniques for sidelink carrier aggregation with Mode 1 sidelink communications in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for sidelink carrier aggregation with Mode 1 sidelink communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for sidelink carrier aggregation with Mode 1 sidelink communications). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for sidelink carrier aggregation with Mode 1 sidelink communications as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving, from a network entity via an access link, a first control message enabling sidelink carrier aggregation between the first UE and a second UE, the sidelink carrier aggregation associated with a set of multiple sidelink carriers for sidelink communication between the first UE and the second UE. The communications manager 720 is capable of, configured to, or operable to support a means for receiving, from the network entity via the access link, one or more second control messages scheduling transmission of a set of multiple sidelink messages over multiple sidelink carriers of the set of multiple sidelink carriers based on the first control message. The communications manager 720 is capable of, configured to, or operable to support a means for communicating the set of multiple sidelink messages via the multiple sidelink carriers associated with the sidelink carrier aggregation based on the one or more second control messages.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for sidelink CA for Mode 1 sidelink communications, which may result in reduced processing, reduced power consumption, and more efficient utilization of communication resources, among other advantages.

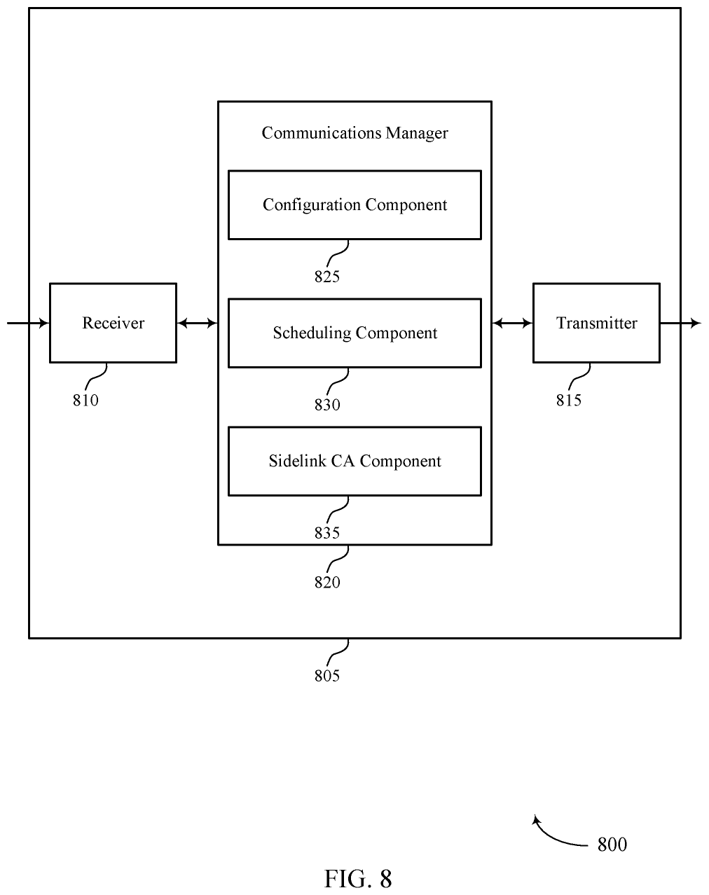

FIG. 8 shows a block diagram 800 of a device 805 that supports techniques for sidelink carrier aggregation with Mode 1 sidelink communications in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for sidelink carrier aggregation with Mode 1 sidelink communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for sidelink carrier aggregation with Mode 1 sidelink communications). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for sidelink carrier aggregation with Mode 1 sidelink communications as described herein. For example, the communications manager 820 may include a configuration component 825, a scheduling component 830, a sidelink CA component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The configuration component 825 is capable of, configured to, or operable to support a means for receiving, from a network entity via an access link, a first control message enabling sidelink carrier aggregation between the first UE and a second UE, the sidelink carrier aggregation associated with a set of multiple sidelink carriers for sidelink communication between the first UE and the second UE. The scheduling component 830 is capable of, configured to, or operable to support a means for receiving, from the network entity via the access link, one or more second control messages scheduling transmission of a set of multiple sidelink messages over multiple sidelink carriers of the set of multiple sidelink carriers based on the first control message. The sidelink CA component 835 is capable of, configured to, or operable to support a means for communicating the set of multiple sidelink messages via the multiple sidelink carriers associated with the sidelink carrier aggregation based on the one or more second control messages.

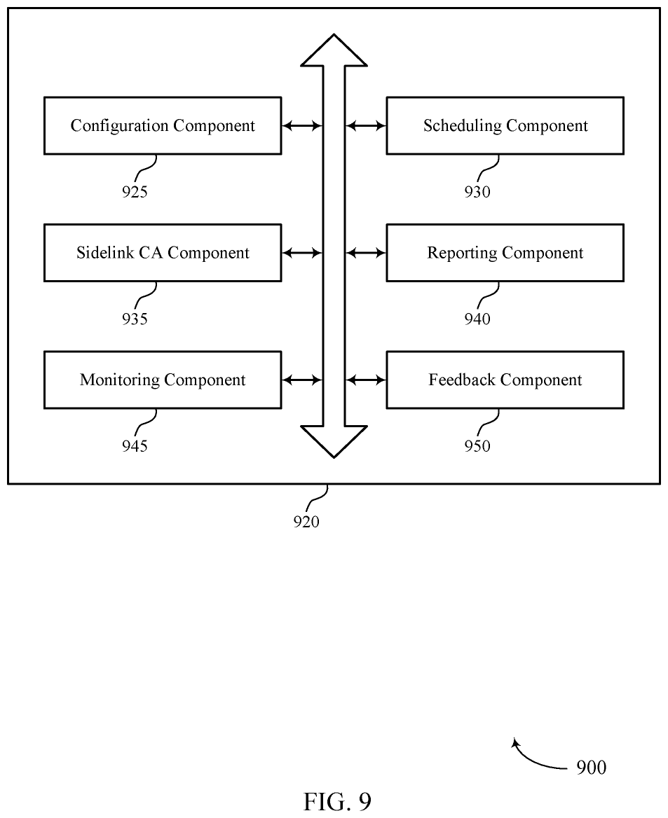

FIG. 9 shows a block diagram 900 of a communications manager 920 that supports techniques for sidelink carrier aggregation with Mode 1 sidelink communications in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for sidelink carrier aggregation with Mode 1 sidelink communications as described herein. For example, the communications manager 920 may include a configuration component 925, a scheduling component 930, a sidelink CA component 935, a reporting component 940, a monitoring component 945, a feedback component 950, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The configuration component 925 is capable of, configured to, or operable to support a means for receiving, from a network entity via an access link, a first control message enabling sidelink carrier aggregation between the first UE and a second UE, the sidelink carrier aggregation associated with a set of multiple sidelink carriers for sidelink communication between the first UE and the second UE. The scheduling component 930 is capable of, configured to, or operable to support a means for receiving, from the network entity via the access link, one or more second control messages scheduling transmission of a set of multiple sidelink messages over multiple sidelink carriers of the set of multiple sidelink carriers based on the first control message. The sidelink CA component 935 is capable of, configured to, or operable to support a means for communicating the set of multiple sidelink messages via the multiple sidelink carriers associated with the sidelink carrier aggregation based on the one or more second control messages.

In some examples, to support receiving the one or more second control messages, the scheduling component 930 is capable of, configured to, or operable to support a means for receiving, via one or more downlink carriers of the access link, a set of multiple second control messages, each second control message of the set of multiple second control messages scheduling a respective sidelink message of the set of multiple sidelink messages over a respective sidelink carrier of the multiple sidelink carriers.

In some examples, the monitoring component 945 is capable of, configured to, or operable to support a means for monitoring, for each second control message of the set of multiple second control messages, up to a first quantity of downlink control channel candidates and up to a second quantity of non-overlapping control channel elements for the set of multiple second control messages.

In some examples, the first quantity and the second quantity are based on a subcarrier spacing of an active downlink bandwidth part associated with the network entity.

In some examples, the set of multiple second control messages are received via a single downlink carrier, and the monitoring component 945 is capable of, configured to, or operable to support a means for monitoring, for each second control message of the set of multiple second control messages, up to a first portion of a first quantity of downlink control channel candidates and up to a second portion of a second quantity of non-overlapping control channel elements.

In some examples, the first quantity and the second quantity are based on a subcarrier spacing of an active downlink bandwidth part associated with the network entity.

In some examples, both a quantity of downlink control channel candidates in the first portion and a quantity of non-overlapping control channel elements in the second portion are the same for each second control message.

In some examples, both a third quantity of downlink control channel candidates in the first portion and a fourth quantity of non-overlapping control channel elements in the second portion are different for each second control message, and the configuration component 925 is capable of, configured to, or operable to support a means for receiving, from the network entity, an indication of respective third quantities and respective second quantities for each second control message of the set of multiple second control messages.

In some examples, to support receiving the one or more second control messages, the scheduling component 930 is capable of, configured to, or operable to support a means for receiving, via a single downlink carrier of the access link, a single second control message, the single second control message scheduling the set of multiple sidelink messages over the multiple sidelink carriers.

In some examples, the single second control message indicates a set of multiple sets of parameters for the set of multiple sidelink messages.

In some examples, a first set of parameters of the set of multiple sets of parameters includes a resource pool index, a time gap, a hybrid automatic repeat request process, a new data indicator, a lowest index of sub-channel, a frequency domain resource assignment, a time domain resource assignment, a feedback timing, an uplink control channel resource, a configuration index, a counter sidelink assignment index, or any combination thereof.

In some examples, the first control message indicates the single downlink carrier is a scheduling downlink carrier.

In some examples, the reporting component 940 is capable of, configured to, or operable to support a means for transmitting, to the network entity via the access link, feedback for the set of multiple sidelink messages.

In some examples, to support transmitting the feedback, the reporting component 940 is capable of, configured to, or operable to support a means for transmitting a single feedback message indicating the feedback for the set of multiple sidelink messages.

In some examples, the feedback component 950 is capable of, configured to, or operable to support a means for receiving, from the second UE via one or more sidelink carriers of the multiple sidelink carriers, a set of multiple sidelink feedback messages indicating the feedback for the set of multiple sidelink messages, where the single feedback message is transmitted a threshold time duration after receipt of a last sidelink feedback message of the set of multiple sidelink feedback messages.

In some examples, to support transmitting the feedback, the reporting component 940 is capable of, configured to, or operable to support a means for transmitting a set of multiple feedback messages for the set of multiple sidelink messages, each feedback message of the set of multiple feedback messages indicating feedback for a respective sidelink message of the set of multiple sidelink messages.

In some examples, the feedback component 950 is capable of, configured to, or operable to support a means for receiving, from the second UE via one or more sidelink carriers of the multiple sidelink carriers, a set of multiple sidelink feedback messages indicating the feedback for the set of multiple sidelink messages, where each feedback message of the set of multiple feedback messages is transmitted a threshold duration after a respective sidelink feedback message of the set of multiple sidelink feedback messages.

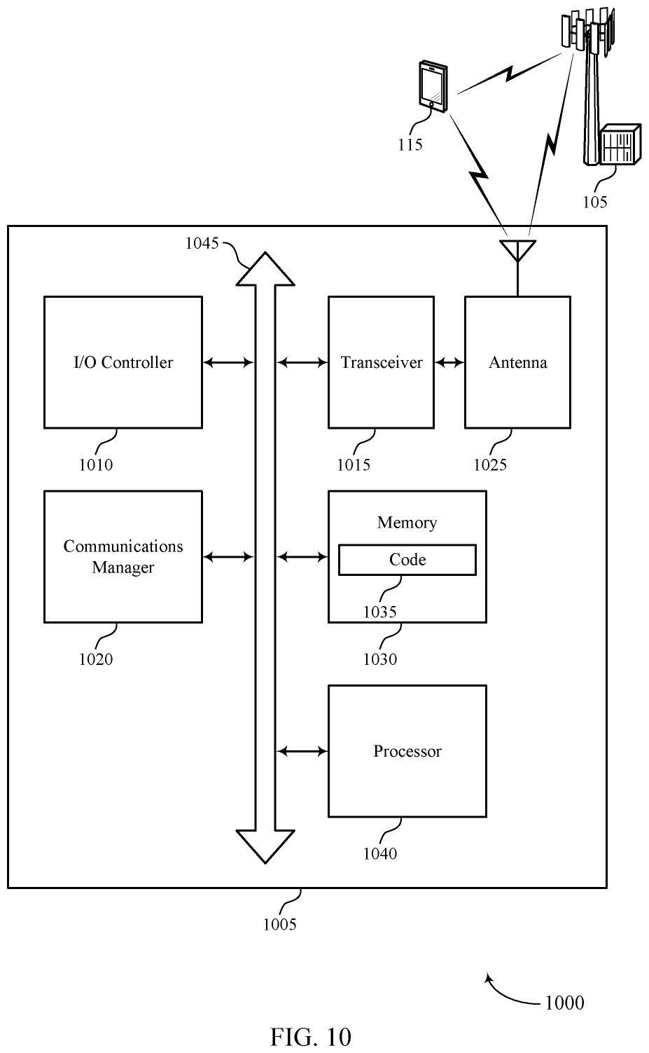

FIG. 10 shows a diagram of a system 1000 including a device 1005 that supports techniques for sidelink carrier aggregation with Mode 1 sidelink communications in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting techniques for sidelink carrier aggregation with Mode 1 sidelink communications). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving, from a network entity via an access link, a first control message enabling sidelink carrier aggregation between the first UE and a second UE, the sidelink carrier aggregation associated with a set of multiple sidelink carriers for sidelink communication between the first UE and the second UE. The communications manager 1020 is capable of, configured to, or operable to support a means for receiving, from the network entity via the access link, one or more second control messages scheduling transmission of a set of multiple sidelink messages over multiple sidelink carriers of the set of multiple sidelink carriers based on the first control message. The communications manager 1020 is capable of, configured to, or operable to support a means for communicating the set of multiple sidelink messages via the multiple sidelink carriers associated with the sidelink carrier aggregation based on the one or more second control messages.

By including or configuring the communications manager 1020 in accordance with examples as described herein, the device 1005 may support techniques for sidelink CA for Mode 1 sidelink communications, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of techniques for sidelink carrier aggregation with Mode 1 sidelink communications as described herein, or the at least one processor 1040 and the at least one memory 1030 may be otherwise configured to, individually or collectively, perform or support such operations.

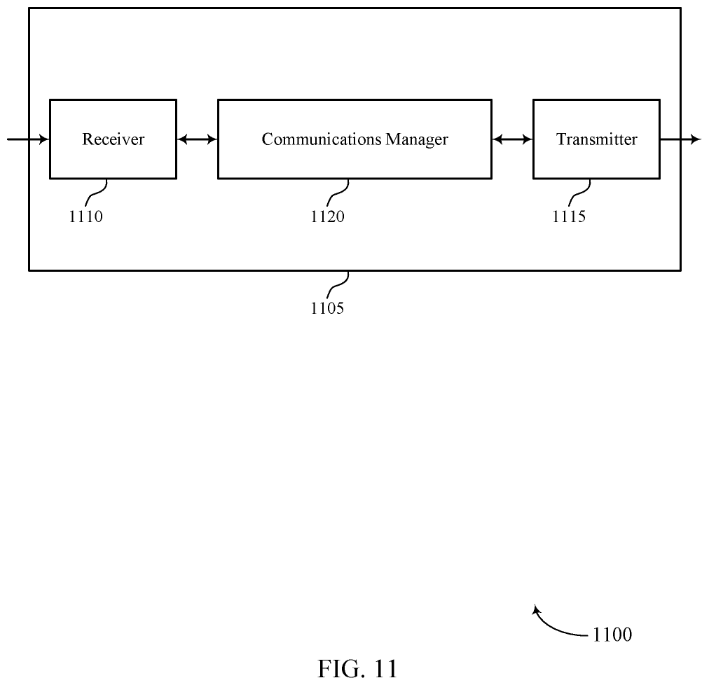

FIG. 11 shows a block diagram 1100 of a device 1105 that supports techniques for sidelink carrier aggregation with Mode 1 sidelink communications in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of techniques for sidelink carrier aggregation with Mode 1 sidelink communications as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for outputting, to a first UE via an access link, a first control message enabling sidelink carrier aggregation between the first UE and a second UE, the sidelink carrier aggregation associated with a set of multiple sidelink carriers for sidelink communication between the first UE and the second UE. The communications manager 1120 is capable of, configured to, or operable to support a means for outputting, to the first UE via the access link, one or more second control messages scheduling transmission of a set of multiple sidelink messages over multiple sidelink carriers of the set of multiple sidelink carriers based on the first control message. The communications manager 1120 is capable of, configured to, or operable to support a means for obtaining, from the first UE via the access link, feedback for the set of multiple sidelink messages.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for sidelink CA for Mode 1 sidelink communications, which may result in reduced processing, reduced power consumption, and more efficient utilization of communication resources, among other advantages.

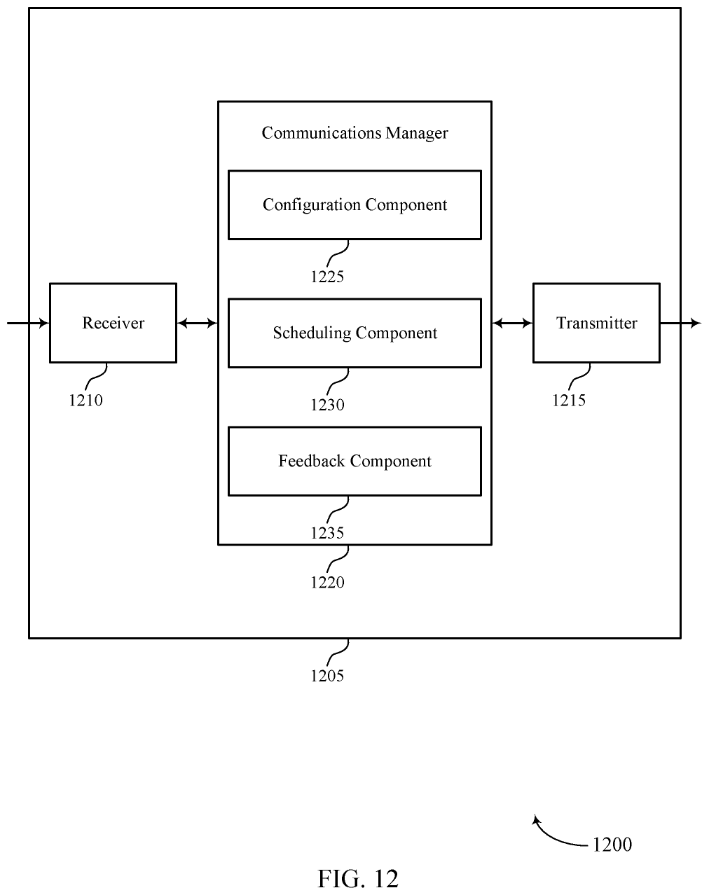

FIG. 12 shows a block diagram 1200 of a device 1205 that supports techniques for sidelink carrier aggregation with Mode 1 sidelink communications in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for sidelink carrier aggregation with Mode 1 sidelink communications as described herein. For example, the communications manager 1220 may include a configuration component 1225, a scheduling component 1230, a feedback component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The configuration component 1225 is capable of, configured to, or operable to support a means for outputting, to a first UE via an access link, a first control message enabling sidelink carrier aggregation between the first UE and a second UE, the sidelink carrier aggregation associated with a set of multiple sidelink carriers for sidelink communication between the first UE and the second UE. The scheduling component 1230 is capable of, configured to, or operable to support a means for outputting, to the first UE via the access link, one or more second control messages scheduling transmission of a set of multiple sidelink messages over multiple sidelink carriers of the set of multiple sidelink carriers based on the first control message. The feedback component 1235 is capable of, configured to, or operable to support a means for obtaining, from the first UE via the access link, feedback for the set of multiple sidelink messages.

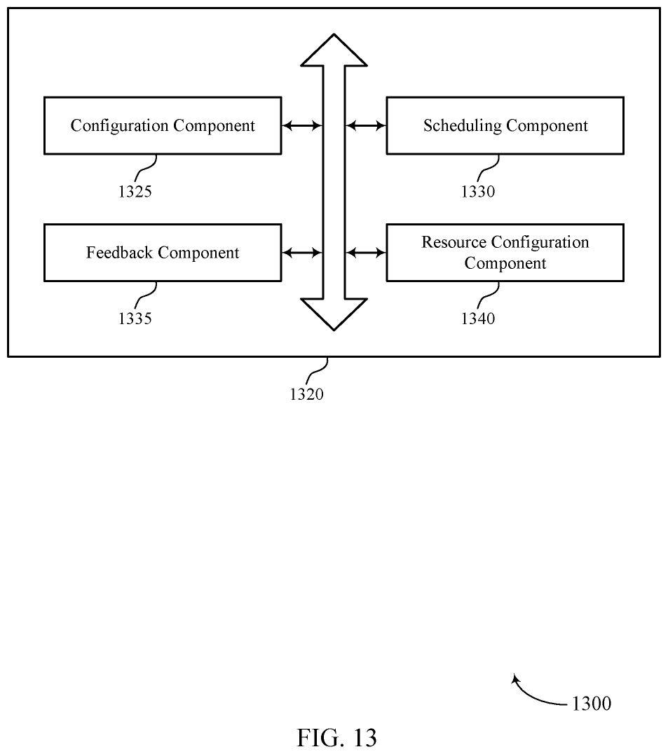

FIG. 13 shows a block diagram 1300 of a communications manager 1320 that supports techniques for sidelink carrier aggregation with Mode 1 sidelink communications in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for sidelink carrier aggregation with Mode 1 sidelink communications as described herein. For example, the communications manager 1320 may include a configuration component 1325, a scheduling component 1330, a feedback component 1335, a resource configuration component 1340, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The configuration component 1325 is capable of, configured to, or operable to support a means for outputting, to a first UE via an access link, a first control message enabling sidelink carrier aggregation between the first UE and a second UE, the sidelink carrier aggregation associated with a set of multiple sidelink carriers for sidelink communication between the first UE and the second UE. The scheduling component 1330 is capable of, configured to, or operable to support a means for outputting, to the first UE via the access link, one or more second control messages scheduling transmission of a set of multiple sidelink messages over multiple sidelink carriers of the set of multiple sidelink carriers based on the first control message. The feedback component 1335 is capable of, configured to, or operable to support a means for obtaining, from the first UE via the access link, feedback for the set of multiple sidelink messages.

In some examples, to support outputting the one or more second control messages, the scheduling component 1330 is capable of, configured to, or operable to support a means for outputting, via a single downlink carrier of the access link, a set of multiple second control messages, each second control message of the set of multiple second control messages scheduling a respective sidelink message of the set of multiple sidelink messages over a respective sidelink carrier of the multiple sidelink carriers.

In some examples, to support outputting the one or more second control messages, the scheduling component 1330 is capable of, configured to, or operable to support a means for outputting, via a set of multiple downlink carriers of the access link, a set of multiple second control messages, each second control message of the set of multiple second control messages scheduling a respective sidelink message of the set of multiple sidelink messages over a respective sidelink carrier of the multiple sidelink carriers.

In some examples, the resource configuration component 1340 is capable of, configured to, or operable to support a means for outputting, to the UE, an indication of respective quantities of downlink control channel candidates and respective quantities of non-overlapping control channel elements for the first UE to monitor for each second control message of the one or more second control messages.

In some examples, to support transmitting the one or more second control messages, the scheduling component 1330 is capable of, configured to, or operable to support a means for outputting, via a single downlink carrier of the access link, a single second control message, the single second control message scheduling the set of multiple sidelink messages over the multiple sidelink carriers.

In some examples, the single second control message indicates a set of multiple sets of parameters for the set of multiple sidelink messages.

In some examples, a first set of parameters of the set of multiple sets of parameters includes a resource pool index, a time gap, a hybrid automatic repeat request process, a new data indicator, a lowest index of sub-channel, a frequency domain resource assignment, a time domain resource assignment, a feedback timing, an uplink control channel resource, a configuration index, a counter sidelink assignment index, or any combination thereof.

In some examples, the first control message indicates the single downlink carrier is a scheduling downlink carrier.

In some examples, to support obtaining the feedback, the feedback component 1335 is capable of, configured to, or operable to support a means for obtaining, via the access link, a single feedback message indicating the feedback for the set of multiple sidelink messages.

In some examples, to support obtaining the feedback, the feedback component 1335 is capable of, configured to, or operable to support a means for obtaining, via the access link, a set of multiple feedback messages for the set of multiple sidelink messages, each feedback message of the set of multiple feedback messages indicating feedback for a respective sidelink message of the set of multiple sidelink messages.

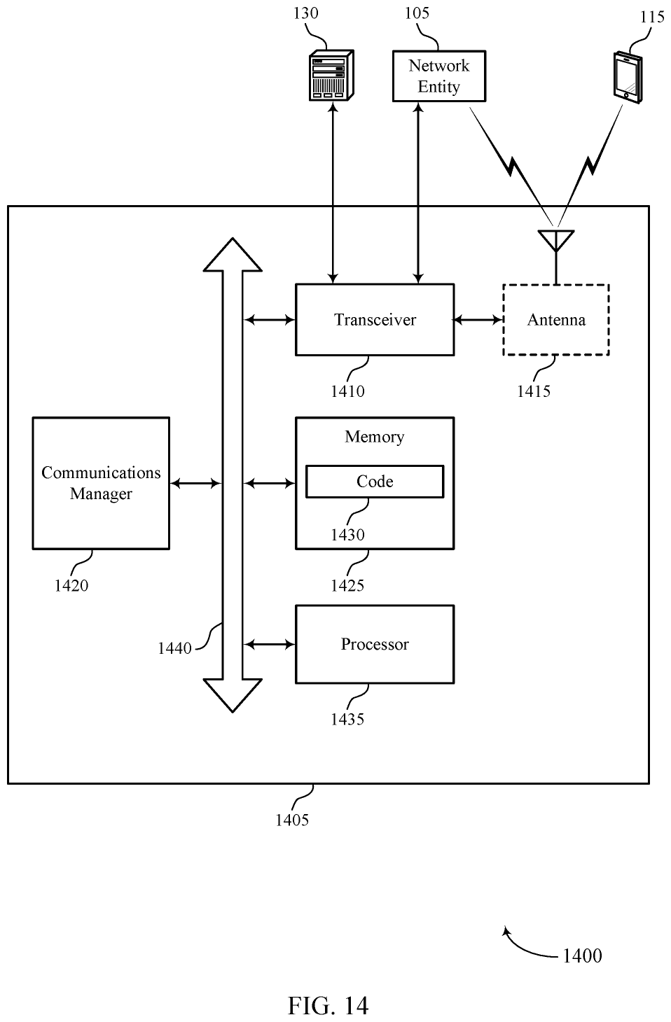

FIG. 14 shows a diagram of a system 1400 including a device 1405 that supports techniques for sidelink carrier aggregation with Mode 1 sidelink communications in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting techniques for sidelink carrier aggregation with Mode 1 sidelink communications). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for outputting, to a first UE via an access link, a first control message enabling sidelink carrier aggregation between the first UE and a second UE, the sidelink carrier aggregation associated with a set of multiple sidelink carriers for sidelink communication between the first UE and the second UE. The communications manager 1420 is capable of, configured to, or operable to support a means for outputting, to the first UE via the access link, one or more second control messages scheduling transmission of a set of multiple sidelink messages over multiple sidelink carriers of the set of multiple sidelink carriers based on the first control message. The communications manager 1420 is capable of, configured to, or operable to support a means for obtaining, from the first UE via the access link, feedback for the set of multiple sidelink messages.

By including or configuring the communications manager 1420 in accordance with examples as described herein, the device 1405 may support techniques for sidelink CA for Mode 1 sidelink communications, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of techniques for sidelink carrier aggregation with Mode 1 sidelink communications as described herein, or the at least one processor 1435 and the at least one memory 1425 may be otherwise configured to, individually or collectively, perform or support such operations.

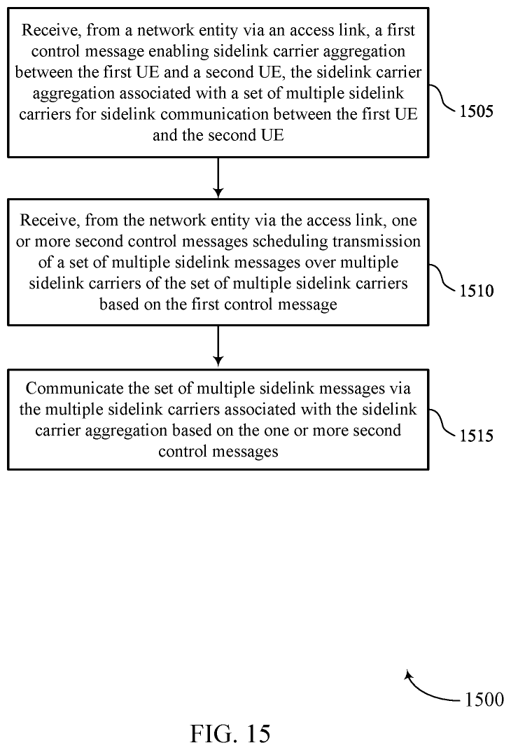

FIG. 15 shows a flowchart illustrating a method 1500 that supports techniques for sidelink carrier aggregation with Mode 1 sidelink communications in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity via an access link, a first control message enabling sidelink carrier aggregation between the first UE and a second UE, the sidelink carrier aggregation associated with a set of multiple sidelink carriers for sidelink communication between the first UE and the second UE. The operations of block 1505 may be performed in accordance with examples as disclosed herein. In some examples, aspects of the operations of 1505 may be performed by a configuration component 925 as described with reference to FIG. 9.

At 1510, the method may include receiving, from the network entity via the access link, one or more second control messages scheduling transmission of a set of multiple sidelink messages over multiple sidelink carriers of the set of multiple sidelink carriers based on the first control message. The operations of block 1510 may be performed in accordance with examples as disclosed herein. In some examples, aspects of the operations of 1510 may be performed by a scheduling component 930 as described with reference to FIG. 9.

At 1515, the method may include communicating the set of multiple sidelink messages via the multiple sidelink carriers associated with the sidelink carrier aggregation based on the one or more second control messages. The operations of block 1515 may be performed in accordance with examples as disclosed herein. In some examples, aspects of the operations of 1515 may be performed by a sidelink CA component 935 as described with reference to FIG. 9.

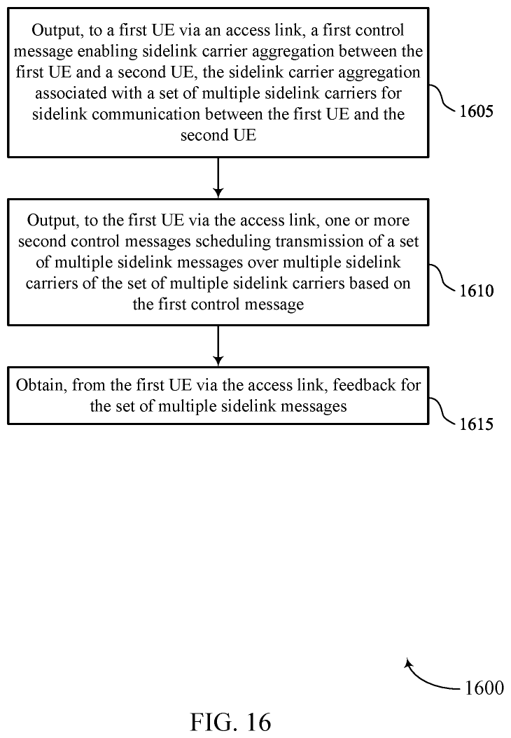

FIG. 16 shows a flowchart illustrating a method 1600 that supports techniques for sidelink carrier aggregation with Mode 1 sidelink communications in accordance with one or more aspects of the present disclosure. The operations of the method 1600 may be implemented by a network entity or its components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include outputting, to a first UE via an access link, a first control message enabling sidelink carrier aggregation between the first UE and a second UE, the sidelink carrier aggregation associated with a set of multiple sidelink carriers for sidelink communication between the first UE and the second UE. The operations of block 1605 may be performed in accordance with examples as disclosed herein. In some examples, aspects of the operations of 1605 may be performed by a configuration component 1325 as described with reference to FIG. 13.

At 1610, the method may include outputting, to the first UE via the access link, one or more second control messages scheduling transmission of a set of multiple sidelink messages over multiple sidelink carriers of the set of multiple sidelink carriers based on the first control message. The operations of block 1610 may be performed in accordance with examples as disclosed herein. In some examples, aspects of the operations of 1610 may be performed by a scheduling component 1330 as described with reference to FIG. 13.

At 1615, the method may include obtaining, from the first UE via the access link, feedback for the set of multiple sidelink messages. The operations of block 1615 may be performed in accordance with examples as disclosed herein. In some examples, aspects of the operations of 1615 may be performed by a feedback component 1335 as described with reference to FIG. 13.

The following provides an overview of aspects of the present disclosure:

Aspect 1: A method for wireless communications at a first UE, comprising: receiving, from a network entity via an access link, a first control message enabling sidelink CA between the first UE and a second UE, the sidelink CA associated with a plurality of sidelink carriers for sidelink communication between the first UE and the second UE; receiving, from the network entity via the access link, one or more second control messages scheduling transmission of a plurality of sidelink messages over multiple sidelink carriers of the plurality of sidelink carriers based at least in part on the first control message; and communicating the plurality of sidelink messages via the multiple sidelink carriers associated with the sidelink carrier aggregation based at least in part on the one or more second control messages.

Aspect 2: The method of aspect 1, wherein receiving the one or more second control messages comprises: receiving, via one or more downlink carriers of the access link, a plurality of second control messages, each second control message of the plurality of second control messages scheduling a respective sidelink message of the plurality of sidelink messages over a respective sidelink carrier of the multiple sidelink carriers.

Aspect 3: The method of aspect 2, further comprising: monitoring, for each second control message of the plurality of second control messages, up to a first quantity of downlink control channel candidates and up to a second quantity of non-overlapping control channel elements for the plurality of second control messages.

Aspect 4: The method of aspect 3, wherein the first quantity and the second quantity are based on a SCS of an active downlink BWP associated with the network entity.

Aspect 5: The method of aspect 2, wherein the plurality of second control messages are received via a single downlink carrier, the method further comprising: monitoring, for each second control message of the plurality of second control messages, up to a first portion of a first quantity of downlink control channel candidates and up to a second portion of a second quantity of non-overlapping control channel elements.

Aspect 6: The method of aspect 5, wherein the first quantity and the second quantity are based on a SCS of an active downlink BWP associated with the network entity.

Aspect 7: The method of any of aspects 5 through 6, wherein both a quantity of downlink control channel candidates in the first portion and a quantity of non-overlapping control channel elements in the second portion are the same for each second control message.

Aspect 8: The method of any of aspects 5 through 6, wherein both a third quantity of downlink control channel candidates in the first portion and a fourth quantity of non-overlapping control channel elements in the second portion are different for each second control message, the method further comprising: receiving, from the network entity, an indication of respective third quantities and respective second quantities for each second control message of the plurality of second control messages.

Aspect 9: The method of aspect 1, wherein receiving the one or more second control messages comprises: receiving, via a single downlink carrier of the access link, a single second control message, the single second control message scheduling the plurality of sidelink messages over the multiple sidelink carriers.

Aspect 10: The method of aspect 9, wherein the single second control message indicates a plurality of sets of parameters for the plurality of sidelink messages.

Aspect 11: The method of aspect 10, wherein a first set of parameters of the plurality of sets of parameters comprises a resource pool index, a time gap, a HARQ process, a new data indicator, a lowest index of sub-channel, a frequency domain resource assignment, a time domain resource assignment, a feedback timing, an uplink control channel resource, a configuration index, a counter sidelink assignment index, or any combination thereof.

Aspect 12: The method of any of aspects 9 through 11, wherein the first control message indicates the single downlink carrier is a scheduling downlink carrier.

Aspect 13: The method of any of aspects 1 through 12, further comprising: transmitting, to the network entity via the access link, feedback for the plurality of sidelink messages.

Aspect 14: The method of aspect 13, wherein transmitting the feedback comprises: transmitting a single feedback message indicating the feedback for the plurality of sidelink messages.

Aspect 15: The method of aspect 14, further comprising: receiving, from the second UE via one or more sidelink carriers of the multiple sidelink carriers, a plurality of sidelink feedback messages indicating the feedback for the plurality of sidelink messages, wherein the single feedback message is transmitted a threshold time duration after receipt of a last sidelink feedback message of the plurality of sidelink feedback messages.

Aspect 16: The method of aspect 13, wherein transmitting the feedback comprises: transmitting a plurality of feedback messages for the plurality of sidelink messages, each feedback message of the plurality of feedback messages indicating feedback for a respective sidelink message of the plurality of sidelink messages.

Aspect 17: The method of aspect 16, further comprising: receiving, from the second UE via one or more sidelink carriers of the multiple sidelink carriers, a plurality of sidelink feedback messages indicating the feedback for the plurality of sidelink messages, wherein each feedback message of the plurality of feedback messages is transmitted a threshold duration after a respective sidelink feedback message of the plurality of sidelink feedback messages.

Aspect 18: A method for wireless communications at a network entity, comprising: outputting, to a first UE via an access link, a first control message enabling sidelink CA between the first UE and a second UE, the sidelink CA associated with a plurality of sidelink carriers for sidelink communication between the first UE and the second UE; outputting, to the first UE via the access link, one or more second control messages scheduling transmission of a plurality of sidelink messages over multiple sidelink carriers of the plurality of sidelink carriers based at least in part on the first control message; and obtaining, from the first UE via the access link, feedback for the plurality of sidelink messages.

Aspect 19: The method of aspect 18, wherein outputting the one or more second control messages comprises: outputting, via a single downlink carrier of the access link, a plurality of second control messages, each second control message of the plurality of second control messages scheduling a respective sidelink message of the plurality of sidelink messages over a respective sidelink carrier of the multiple sidelink carriers.

Aspect 20: The method of aspect 18, wherein outputting the one or more second control messages comprises: outputting, via a plurality of downlink carriers of the access link, a plurality of second control messages, each second control message of the plurality of second control messages scheduling a respective sidelink message of the plurality of sidelink messages over a respective sidelink carrier of the multiple sidelink carriers.

Aspect 21: The method of any of aspects 18 through 20, further comprising: outputting, to the UE, an indication of respective quantities of downlink control channel candidates and respective quantities of non-overlapping control channel elements for the first UE to monitor for each second control message of the one or more second control messages.

Aspect 22: The method of any of aspects 18 and 21, wherein transmitting the one or more second control messages comprises: outputting, via a single downlink carrier of the access link, a single second control message, the single second control message scheduling the plurality of sidelink messages over the multiple sidelink carriers.

Aspect 23: The method of aspect 22, wherein the single second control message indicates a plurality of sets of parameters for the plurality of sidelink messages.

Aspect 24: The method of aspect 23, wherein a first set of parameters of the plurality of sets of parameters comprises a resource pool index, a time gap, a HARQ process, a new data indicator, a lowest index of sub-channel, a frequency domain resource assignment, a time domain resource assignment, a feedback timing, an uplink control channel resource, a configuration index, a counter sidelink assignment index, or any combination thereof.

Aspect 25: The method of any of aspects 22 through 24, wherein the first control message indicates the single downlink carrier is a scheduling downlink carrier.

Aspect 26: The method of any of aspects 18 through 25, wherein obtaining the feedback comprises: obtaining, via the access link, a single feedback message indicating the feedback for the plurality of sidelink messages.

Aspect 27: The method of any of aspects 18 through 25, wherein obtaining the feedback comprises: obtaining, via the access link, a plurality of feedback messages for the plurality of sidelink messages, each feedback message of the plurality of feedback messages indicating feedback for a respective sidelink message of the plurality of sidelink messages.

Aspect 28: A first UE for wireless communications, comprising one or more memories storing processor-executable code, and one or more processors coupled with the one or more memories and individually or collectively operable to execute the code to cause the first UE to perform a method of any of aspects 1 through 17.

Aspect 29: A first UE for wireless communications, comprising at least one means for performing a method of any of aspects 1 through 17.

Aspect 30: A non-transitory computer-readable medium storing code for wireless communications, the code comprising instructions executable by one or more processors to perform a method of any of aspects 1 through 17.

Aspect 31: A network entity for wireless communications, comprising one or more memories storing processor-executable code, and one or more processors coupled with the one or more memories and individually or collectively operable to execute the code to cause the network entity to perform a method of any of aspects 18 through 27.

Aspect 32: A network entity for wireless communications, comprising at least one means for performing a method of any of aspects 18 through 27.

Aspect 33: A non-transitory computer-readable medium storing code for wireless communications, the code comprising instructions executable by one or more processors to perform a method of any of aspects 18 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
one or more memories storing processor-executable code; and
one or more processors coupled with the one or more memories and individually or collectively operable to execute the code to cause the first UE to:
receive, from a network entity via an access link, a first control message enabling sidelink carrier aggregation between the first UE and a second UE, the sidelink carrier aggregation associated with a plurality of sidelink carriers for sidelink communication between the first UE and the second UE;
receive, from the network entity via the access link, one or more second control messages scheduling transmission of a plurality of sidelink messages over multiple sidelink carriers of the plurality of sidelink carriers based at least in part on the first control message; and
communicate the plurality of sidelink messages via the multiple sidelink carriers associated with the sidelink carrier aggregation based at least in part on the one or more second control messages.

2. The first UE of claim 1, wherein, to receive the one or more second control messages, the one or more processors are individually or collectively operable to execute the code to cause the first UE to:
receive, via one or more downlink carriers of the access link, a plurality of second control messages, each second control message of the plurality of second control messages scheduling a respective sidelink message of the plurality of sidelink messages over a respective sidelink carrier of the multiple sidelink carriers.

3. The first UE of claim 2, wherein the one or more processors are individually or collectively further operable to execute the code to cause the first UE to:
monitor, for each second control message of the plurality of second control messages, up to a first quantity of downlink control channel candidates and up to a second quantity of non-overlapping control channel elements for the plurality of second control messages.

4. The first UE of claim 3, wherein the first quantity and the second quantity are based on a subcarrier spacing of an active downlink bandwidth part associated with the network entity.

5. The first UE of claim 2, wherein the plurality of second control messages are received via a single downlink carrier, and the one or more processors are individually or collectively further operable to execute the code to cause the first UE to:
monitor, for each second control message of the plurality of second control messages, up to a first portion of a first quantity of downlink control channel candidates and up to a second portion of a second quantity of non-overlapping control channel elements.

6. The first UE of claim 5, wherein the first quantity and the second quantity are based on a subcarrier spacing of an active downlink bandwidth part associated with the network entity.

7. The first UE of claim 5, wherein both a quantity of downlink control channel candidates in the first portion and a quantity of non-overlapping control channel elements in the second portion are the same for each second control message.

8. The first UE of claim 5, wherein both a third quantity of downlink control channel candidates in the first portion and a fourth quantity of non-overlapping control channel elements in the second portion are different for each second control message, and the one or more processors are individually or collectively further operable to execute the code to cause the first UE to:
receive, from the network entity, an indication of respective third quantities and respective second quantities for each second control message of the plurality of second control messages.

9. The first UE of claim 1, wherein, to receive the one or more second control messages, the one or more processors are individually or collectively operable to execute the code to cause the first UE to:
receive, via a single downlink carrier of the access link, a single second control message, the single second control message scheduling the plurality of sidelink messages over the multiple sidelink carriers.

10. The first UE of claim 9, wherein the single second control message indicates a plurality of sets of parameters for the plurality of sidelink messages.

11. The first UE of claim 10, wherein a first set of parameters of the plurality of sets of parameters comprises a resource pool index, a time gap, a hybrid automatic repeat request process, a new data indicator, a lowest index of sub-channel, a frequency domain resource assignment, a time domain resource assignment, a feedback timing, an uplink control channel resource, a configuration index, a counter sidelink assignment index, or any combination thereof.

12. The first UE of claim 9, wherein the first control message indicates the single downlink carrier is a scheduling downlink carrier.

13. The first UE of claim 1, wherein the one or more processors are individually or collectively further operable to execute the code to cause the first UE to:
transmit, to the network entity via the access link, feedback for the plurality of sidelink messages.

14. The first UE of claim 13, wherein, to transmit the feedback, the one or more processors are individually or collectively operable to execute the code to cause the first UE to:
transmit a single feedback message indicating the feedback for the plurality of sidelink messages.

15. The first UE of claim 14, wherein the one or more processors are individually or collectively further operable to execute the code to cause the first UE to:
receive, from the second UE via one or more sidelink carriers of the multiple sidelink carriers, a plurality of sidelink feedback messages indicating the feedback for the plurality of sidelink messages, wherein the single feedback message is transmitted a threshold time duration after receipt of a last sidelink feedback message of the plurality of sidelink feedback messages.

16. The first UE of claim 13, wherein, to transmit the feedback, the one or more processors are individually or collectively operable to execute the code to cause the first UE to:
transmit a plurality of feedback messages for the plurality of sidelink messages, each feedback message of the plurality of feedback messages indicating feedback for a respective sidelink message of the plurality of sidelink messages.

17. The first UE of claim 16, wherein the one or more processors are individually or collectively further operable to execute the code to cause the first UE to:
receive, from the second UE via one or more sidelink carriers of the multiple sidelink carriers, a plurality of sidelink feedback messages indicating the feedback for the plurality of sidelink messages, wherein each feedback message of the plurality of feedback messages is transmitted a threshold duration after a respective sidelink feedback message of the plurality of sidelink feedback messages.

18. A network entity, comprising:
one or more memories storing processor-executable code; and
one or more processors coupled with the one or more memories and individually or collectively operable to execute the code to cause the network entity to:
output, to a first user equipment (UE) via an access link, a first control message enabling sidelink carrier aggregation between the first UE and a second UE, the sidelink carrier aggregation associated with a plurality of sidelink carriers for sidelink communication between the first UE and the second UE;
output, to the first UE via the access link, one or more second control messages scheduling transmission of a plurality of sidelink messages over multiple sidelink carriers of the plurality of sidelink carriers based at least in part on the first control message; and
obtain, from the first UE via the access link, feedback for the plurality of sidelink messages.

19. The network entity of claim 18, wherein, to output the one or more second control messages, the one or more processors are individually or collectively operable to execute the code to cause the network entity to:
output, via a single downlink carrier of the access link, a plurality of second control messages, each second control message of the plurality of second control messages scheduling a respective sidelink message of the plurality of sidelink messages over a respective sidelink carrier of the multiple sidelink carriers.

20. The network entity of claim 18, wherein, to output the one or more second control messages, the one or more processors are individually or collectively operable to execute the code to cause the network entity to:
output, via a plurality of downlink carriers of the access link, a plurality of second control messages, each second control message of the plurality of second control messages scheduling a respective sidelink message of the plurality of sidelink messages over a respective sidelink carrier of the multiple sidelink carriers.

21. The network entity of claim 18, wherein the one or more processors are individually or collectively further operable to execute the code to cause the network entity to:
output, to the UE, an indication of respective quantities of downlink control channel candidates and respective quantities of non-overlapping control channel elements for the first UE to monitor for each second control message of the one or more second control messages.

22. The network entity of claim 18, wherein, to transmit the one or more second control messages, the one or more processors are individually or collectively operable to execute the code to cause the network entity to:
output, via a single downlink carrier of the access link, a single second control message, the single second control message scheduling the plurality of sidelink messages over the multiple sidelink carriers.

23. The network entity of claim 22, wherein the single second control message indicates a plurality of sets of parameters for the plurality of sidelink messages.

24. The network entity of claim 23, wherein a first set of parameters of the plurality of sets of parameters comprises a resource pool index, a time gap, a hybrid automatic repeat request process, a new data indicator, a lowest index of sub-channel, a frequency domain resource assignment, a time domain resource assignment, a feedback timing, an uplink control channel resource, a configuration index, a counter sidelink assignment index, or any combination thereof.

25. The network entity of claim 18, wherein, to obtain the feedback, the one or more processors are individually or collectively operable to execute the code to cause the network entity to:
obtain, via the access link, a single feedback message indicating the feedback for the plurality of sidelink messages.

26. The network entity of claim 18, wherein, to obtain the feedback, the one or more processors are individually or collectively operable to execute the code to cause the network entity to:
obtain, via the access link, a plurality of feedback messages for the plurality of sidelink messages, each feedback message of the plurality of feedback messages indicating feedback for a respective sidelink message of the plurality of sidelink messages.

27. A method for wireless communications at a first user equipment (UE), comprising:
receiving, from a network entity via an access link, a first control message enabling sidelink carrier aggregation between the first UE and a second UE, the sidelink carrier aggregation associated with a plurality of sidelink carriers for sidelink communication between the first UE and the second UE;
receiving, from the network entity via the access link, one or more second control messages scheduling transmission of a plurality of sidelink messages over multiple sidelink carriers of the plurality of sidelink carriers based at least in part on the first control message; and
communicating the plurality of sidelink messages via the multiple sidelink carriers associated with the sidelink carrier aggregation based at least in part on the one or more second control messages.

28. The method of claim 27, wherein receiving the one or more second control messages comprises:
receiving, via one or more downlink carriers of the access link, a plurality of second control messages, each second control message of the plurality of second control messages scheduling a respective sidelink message of the plurality of sidelink messages over a respective sidelink carrier of the multiple sidelink carriers.

29. The method of claim 27, wherein receiving the one or more second control messages comprises:
receiving, via a single downlink carrier of the access link, a single second control message, the single second control message scheduling the plurality of sidelink messages over the multiple sidelink carriers.

30. A method for wireless communications at a network entity, comprising:
outputting, to a first user equipment (UE) via an access link, a first control message enabling sidelink carrier aggregation between the first UE and a second UE, the sidelink carrier aggregation associated with a plurality of sidelink carriers for sidelink communication between the first UE and the second UE;
outputting, to the first UE via the access link, one or more second control messages scheduling transmission of a plurality of sidelink messages over multiple sidelink carriers of the plurality of sidelink carriers based at least in part on the first control message; and
obtaining, from the first UE via the access link, feedback for the plurality of sidelink messages.
